(19) United States
(12) Patent Application Publication
(10) Pub. No.: US 2018/0041415 A1
(43) Pub. Date: Feb. 8, 2018

(54) MITIGATION OF TRANSMISSION CONTROL PROTOCOL THROUGHPUT DEGRADATION IN COMMUNICATION DEVICES DUE TO PREDICTABLE RADIO IMPAIRMENT EVENTS

(71) Applicant: QUALCOMM Incorporated, San Diego, CA (US)

(72) Inventors: Sirin Nitinawarat, San Diego, CA (US); Arnaud Meylan, San Diego, CA (US); Sivaramakrishna Veerepalli, San Diego, CA (US)

(21) Appl. No.: 15/227,720

(22) Filed: Aug. 3, 2016

(51) Int. Cl. H04L 12/26; H04W 36/00; H04L 5/00; H04W 24/04; H04W 48/16; H04L 29/06; H04W 68/02

(52) U.S. Cl. CPC H04L 43/106; H04L 69/16; H04W 36/0016; H04W 68/02; H04W 24/04; H04L 69/22; H04W 48/16; H04L 5/0055; H04L 5/0007

(57) ABSTRACT

Methods, systems, and devices for wireless communication are described. A communication device may rewrite a TCP timestamp, delay sending of a TCP acknowledgement packet, or both, to reduce the likelihood that a TCP connection times out during a radio impairment event. The may establish a transmission control protocol (TCP) connection with a remote host via a first radio access technology (RAT). The communication device may determine a time stamp value associated with traffic of the TCP connection. The communication device may adjust the time stamp value in a TCP header based at least in part on a radio impairment event that is scheduled or predicted to occur within a defined amount of time. The communication device may also determine a duration of a delay and delay communicating a TCP acknowledgement packet over the TCP connection by at least the duration of the delay.

### BACKGROUND

The following relates generally to wireless communication, and more specifically to mitigation of throughput degradation in communication devices due to predictable radio impairment events.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations or access points (e.g., Wi-Fi access points), each simultaneously supporting communication for multiple communication devices.

TCP (Transmission Control Protocol) defines how software applications establish and maintain a network connection to exchange data. TCP is a connection-oriented protocol in which a TCP connection is established and maintained until the software applications at each end have completed exchanging data. TCP breaks application data into TCP packets for communication over a network, acknowledges packets that are properly received via the network, and requests retransmission of packets that are not received or have errors. TCP sets a timeout value for TCP packets transmitted most recently in which a receiver is to acknowledge. If a timer expires prior to receiving acknowledgement, a transmitter retransmits the TCP packet. In some instances, TCP retransmissions may be unnecessary and reduce network throughput for TCP packets that have been correctly received.

### SUMMARY

A communication device may rewrite a TCP timestamp, delay sending of a TCP acknowledgement packet, or both, to influence a retransmission timeout value used by a remote host for determining when to retransmit a TCP packet, thereby reducing the likelihood of a retransmission timeout occurring during a radio impairment event. In an example, a communication device may support multiple radio access technologies (RATs) that are capable of providing the communication device with concurrent connections to two or more networks. The communication device may establish a transmission control protocol (TCP) connection with a remote host via a first radio access technology (RAT). The first RAT, for example, may provide access to an LTE network. The communication device may have a second, or concurrent, RAT providing access to a second network, such as, for example, a CDMA2000 1× network. The communication device may determine a time stamp value associated with traffic of the TCP connection. The communication device may adjust the time stamp value based at least in part on a radio impairment event that is scheduled or predicted to occur within a defined amount of time. A tuneaway event is an example of a radio impairment event, occurs where the communication device allocates resources to the second RAT, and prevents the first RAT from using the resources for a defined range of time. Predicting that an error rate of TCP packets sent via a TCP connection will exceed a threshold is another example of a radio impairment event. Because tuneaways and other radio impairment events can be regularly scheduled or predicted to occur, the communication device may adjust time stamp values in TCP packets or delay sending acknowledgement packets in anticipation of an upcoming radio impairment event to influence a retransmission timeout value and reduce the likelihood of a TCP connection timing out during the radio impairment event.

A method of wireless communication is described. The method may include establishing a transmission control protocol (TCP) connection with a remote host via a first radio access technology (RAT), determining a time stamp value associated with traffic of the TCP connection, and adjusting the time stamp value in a TCP header based at least in part on a radio impairment event, wherein the radio impairment event is scheduled or predicted to occur within a defined amount of time.

An apparatus for wireless communication is described. The apparatus may include means for establishing a transmission control protocol (TCP) connection with a remote host via a first radio access technology (RAT), means for determining a time stamp value associated with traffic of the TCP connection, and means for adjusting the time stamp value in a TCP header based at least in part on a radio impairment event, wherein the radio impairment event is scheduled or predicted to occur within a defined amount of time.

Another apparatus for wireless communication is described. The apparatus may include a processor, memory in electronic communication with the processor, and instructions stored in the memory. The instructions may be operable to cause the processor to establish a transmission control protocol (TCP) connection with a remote host via a first radio access technology (RAT), determine a time stamp value associated with traffic of the TCP connection, and adjust the time stamp value in a TCP header based at least in part on a radio impairment event, wherein the radio impairment event is scheduled or predicted to occur within a defined amount of time.

A non-transitory computer-readable medium for wireless communication is described. The non-transitory computer-readable medium may include instructions operable to cause a processor to establish a transmission control protocol (TCP) connection with a remote host via a first radio access technology (RAT), determine a time stamp value associated with traffic of the TCP connection, and adjust the time stamp value in a TCP header based at least in part on a radio impairment event, wherein the radio impairment event is scheduled or predicted to occur within a defined amount of time.

Some examples of the method, apparatus, and non-transitory computer-readable medium described above may further include processes, features, means, or instructions for transmitting a TCP packet comprising the adjusted time stamp value over the TCP connection prior to the radio impairment event.

In some examples of the method, apparatus, and non-transitory computer-readable medium described above, adjusting the time stamp value comprises: determining a clock granularity between a modem and at least one of a local operating system of a communication device or the remote host.

In some examples of the method, apparatus, and non-transitory computer-readable medium described above, adjusting the time stamp value comprises: determining an amount of time to adjust the time stamp value based at least in part on the clock granularity. Some examples of the method, apparatus, and non-transitory computer-readable medium described above may further include processes, features, means, or instructions for translating the determined amount of time into a time unit of the local operating system of the communication device or the remote host.

Some examples of the method, apparatus, and non-transitory computer-readable medium described above may further include processes, features, means, or instructions for determining a round trip time associated with the TCP connection based at least in part on the clock granularity, wherein the time stamp value may be adjusted based at least in part on the round trip time or a defined range of a duration of the radio impairment event.

Some examples of the method, apparatus, and non-transitory computer-readable medium described above may further include processes, features, means, or instructions for receiving, at a first time, a first TCP packet comprising a first time stamp value. Some examples of the method, apparatus, and non-transitory computer-readable medium described above may further include processes, features, means, or instructions for receiving, at a second time, a second TCP packet comprising a second time stamp value, wherein the clock granularity may be based at least in part on the first time, the first time stamp value, the second time, and the second time stamp value.

In some examples of the method, apparatus, and non-transitory computer-readable medium described above, an amount of adjustment to the time stamp value may be further based at least in part on the clock granularity or a defined range of a duration of the radio impairment event.

Some examples of the method, apparatus, and non-transitory computer-readable medium described above may further include processes, features, means, or instructions for allocating, for a time period associated with a defined range of a duration of the radio impairment event, use of a subset of resources to a second RAT and simultaneously preventing the first RAT from using the subset of resources during the time period.

Some examples of the method, apparatus, and non-transitory computer-readable medium described above may further include processes, features, means, or instructions for monitoring, via the subset of resources, for a paging signal over the second RAT during the time period.

In some examples of the method, apparatus, and non-transitory computer-readable medium described above, the radio impairment event may be a tuneaway event.

In some examples of the method, apparatus, and non-transitory computer-readable medium described above, the TCP connection may be associated with a TCP clock.

Some examples of the method, apparatus, and non-transitory computer-readable medium described above may further include processes, features, means, or instructions for detecting an error rate. Some examples of the method, apparatus, and non-transitory computer-readable medium described above may further include processes, features, means, or instructions for predicting occurrence of the radio impairment event based at least part on the detected error rate.

Some examples of the method, apparatus, and non-transitory computer-readable medium described above may further include processes, features, means, or instructions for detecting that a handover may be to occur. Some examples of the method, apparatus, and non-transitory computer-readable medium described above may further include processes, features, means, or instructions for predicting occurrence of the radio impairment event based at least part on the detected handover.

A method of wireless communication is described. The method may include establishing a transmission control protocol (TCP) connection with a remote host via a first radio access technology (RAT), determining that a radio impairment event is scheduled or predicted to occur within a defined amount of time, determining a duration of a delay based at least in part on a defined range of time of the radio impairment event, and delaying communicating a TCP acknowledgement packet over the TCP connection by at least the duration of the delay.

An apparatus for wireless communication is described. The apparatus may include means for establishing a transmission control protocol (TCP) connection with a remote host via a first radio access technology (RAT), means for determining that a radio impairment event is scheduled or predicted to occur within a defined amount of time, means for determining a duration of a delay based at least in part on a defined range of time of the radio impairment event, and means for delaying communicating a TCP acknowledgement packet over the TCP connection by at least the duration of the delay.

Another apparatus for wireless communication is described. The apparatus may include a processor, memory in electronic communication with the processor, and instructions stored in the memory. The instructions may be operable to cause the processor to establish a transmission control protocol (TCP) connection with a remote host via a first radio access technology (RAT), determine that a radio impairment event is scheduled or predicted to occur within a defined amount of time, determine a duration of a delay based at least in part on a defined range of time of the radio impairment event, and delay communicating a TCP acknowledgement packet over the TCP connection by at least the duration of the delay.

A non-transitory computer-readable medium for wireless communication is described. The non-transitory computer-readable medium may include instructions operable to cause a processor to establish a transmission control protocol (TCP) connection with a remote host via a first radio access technology (RAT), determine that a radio impairment event is scheduled or predicted to occur within a defined amount of time, determine a duration of a delay based at least in part on a defined range of time of the radio impairment event, and delay communicating a TCP acknowledgement packet over the TCP connection by at least the duration of the delay.

Some examples of the method, apparatus, and non-transitory computer-readable medium described above may further include processes, features, means, or instructions for transmitting the TCP acknowledgement packet over the TCP connection prior to the radio impairment event.

In some examples of the method, apparatus, and non-transitory computer-readable medium described above, determining the duration of the delay further comprises: determining a current time relative to when the radio impairment event may be scheduled or predicted to occur. Some examples of the method, apparatus, and non-transitory computer-readable medium described above may further include processes, features, means, or instructions for associating the current time with a particular one of a plurality of time regions with respect to the radio impairment event, wherein the duration of the delay may be further based at least in part on the particular time region.

Some examples of the method, apparatus, and non-transitory computer-readable medium described above may further include processes, features, means, or instructions for determining a round trip time associated with the TCP connection, wherein each of the plurality of time regions may be associated with a different calculation for determining the duration of the delay as a function of the round trip time or a defined range of a duration of the radio impairment event.

In some examples of the method, apparatus, and non-transitory computer-readable medium described above, the particular time region comprises a first time region, and wherein determining the duration of the delay comprises: calculating the duration of the delay as a function of the round trip time or the defined range of the duration of the radio impairment event, wherein the duration of the delay linearly increases across the first time region as the current time approaches a time of the radio impairment event.

In some examples of the method, apparatus, and non-transitory computer-readable medium described above, the particular time region comprises a second time region, and wherein determining the duration of the delay comprises: calculating a constant value for the duration of the delay as a function of the round trip time or the defined range of the duration of the radio impairment event.

In some examples of the method, apparatus, and non-transitory computer-readable medium described above, the particular time region comprises a third time region, and wherein determining the duration of the delay comprises: calculating the duration of the delay as a function of the round trip time or the defined range of the duration of the radio impairment event, wherein the duration of the delay linearly decreases across the third time region as the current time approaches a time of the radio impairment event.

Some examples of the method, apparatus, and non-transitory computer-readable medium described above may further include processes, features, means, or instructions for generating a consolidated TCP acknowledgement packet based at least in part on the current time and the time of the radio impairment event, wherein the consolidated TCP acknowledgement packet includes acknowledgement data for a plurality of TCP packets received over the TCP connection.

Some examples of the method, apparatus, and non-transitory computer-readable medium described above may further include processes, features, means, or instructions for transmitting the consolidated TCP acknowledgement packet at a fixed amount of time prior to the radio impairment event.

In some examples of the method, apparatus, and non-transitory computer-readable medium described above, determining the duration of a delay comprises: determining a clock granularity between a modem and at least one of a local operating system or the remote host.

In some examples of the method, apparatus, and non-transitory computer-readable medium described above, determining the duration of a delay comprises: determining an amount of time based at least in part on the clock granularity. Some examples of the method, apparatus, and non-transitory computer-readable medium described above may further include processes, features, means, or instructions for translating the determined amount of time into a time unit of the local operating system or the remote host.

In some examples of the method, apparatus, and non-transitory computer-readable medium described above, determining the clock granularity comprises: receiving, at a first time, a first TCP packet having a first time stamp value. Some examples of the method, apparatus, and non-transitory computer-readable medium described above may further include processes, features, means, or instructions for receiving, at a second time, a second TCP packet having a second time stamp value, wherein the clock granularity may be based at least in part on the first time, the first time stamp value, the second time, and the second time stamp value.

Some examples of the method, apparatus, and non-transitory computer-readable medium described above may further include processes, features, means, or instructions for determining a round trip time associated with the TCP connection based at least in part on the clock granularity.

Some examples of the method, apparatus, and non-transitory computer-readable medium described above may further include processes, features, means, or instructions for determining that the radio impairment event may be scheduled or predicted to occur within the defined amount of time may be based at least in part on the round trip time.

In some examples of the method, apparatus, and non-transitory computer-readable medium described above, the TCP connection may be associated with a TCP clock.

In some examples of the method, apparatus, and non-transitory computer-readable medium described above, delaying communicating the TCP acknowledgement packet comprises: delaying transmitting the TCP acknowledgement packet to a lower radio layer.

In some examples of the method, apparatus, and non-transitory computer-readable medium described above, delaying communicating the TCP acknowledgement packet comprises: delaying reception of the TCP acknowledgement packet by an upper radio layer.

Some examples of the method, apparatus, and non-transitory computer-readable medium described above may further include processes, features, means, or instructions for detecting an error rate. Some examples of the method, apparatus, and non-transitory computer-readable medium described above may further include processes, features, means, or instructions for predicting occurrence of the radio impairment event based at least part on the detected error rate.

Some examples of the method, apparatus, and non-transitory computer-readable medium described above may further include processes, features, means, or instructions for detecting that a handover may be to occur. Some examples of the method, apparatus, and non-transitory computer-readable medium described above may further include processes, features, means, or instructions for predicting occurrence of the radio impairment event based at least part on the detected handover.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 illustrates an example of a system for wireless communication that supports mitigation of throughput degradation due to predictable radio impairment events in accordance with aspects of the present disclosure.

FIG. 2 illustrates an example swim lane diagram that supports mitigation of throughput degradation due to predictable radio impairment events in accordance with aspects of the present disclosure.

FIG. 3 illustrates an example swim lane diagram that supports mitigation of throughput degradation due to predictable radio impairment events in accordance with aspects of the present disclosure.

FIG. 4 illustrates an example swim lane diagram that supports mitigation of throughput degradation due to predictable radio impairment events in accordance with aspects of the present disclosure.

FIG. 5 illustrates an example swim lane diagram that supports mitigation of throughput degradation due to predictable radio impairment events in accordance with aspects of the present disclosure.

FIG. 6 illustrates an example swim lane diagram that supports mitigation of throughput degradation due to predictable radio impairment events in accordance with aspects of the present disclosure.

FIG. 7 illustrates an example swim lane diagram that supports mitigation of throughput degradation due to predictable radio impairment events in accordance with aspects of the present disclosure.

FIG. 8 illustrates an example flow chart that supports mitigation of throughput degradation due to predictable radio impairment events in accordance with aspects of the present disclosure.

FIG. 9 illustrates an example swim lane diagram that supports mitigation of throughput degradation due to predictable radio impairment events in accordance with aspects of the present disclosure.

FIG. 10 illustrates an example chart that supports mitigation of throughput degradation due to predictable radio impairment events in accordance with aspects of the present disclosure.

FIGS. 11 through 13 show block diagrams of a device that supports mitigation of throughput degradation due to predictable radio impairment events in accordance with aspects of the present disclosure.

FIG. 14 illustrates a block diagram of a system including a communication device that supports mitigation of throughput degradation due to predictable radio impairment events in accordance with aspects of the present disclosure.

FIGS. 15 through 19 illustrate methods for mitigation of throughput degradation due to predictable radio impairment events in accordance with aspects of the present disclosure.

### DETAILED DESCRIPTION

TCP retransmission timeouts due to radio impairment events may cause excessive throughput loss and unneeded retransmissions of data. A radio impairment event may be scheduled or unscheduled, and may prevent a communication device from timely acknowledging a correctly received TCP packet. Failure to timely acknowledge may result in a TCP retransmission timeout and redundant retransmission of a correctly received TCP packet. A tuneaway event is an example of a scheduled radio impairment event, and predicting a high error rate is an example of an unscheduled radio impairment event.

In one example, a communication device may support multiple concurrent radio access technologies (RATs) and a radio impairment event may occur at scheduled intervals where a communication resource is taken away from a first RAT that is currently supporting data traffic. In some instances, a communication device may allocate a subset of its resources (e.g., at least one antenna) to one RAT during a time period while simultaneously preventing another RAT from using the resources during the time period. In one example, a first RAT may provide access to an LTE network and a second RAT may provide access to a CDMA2000 1× network. In another example for a communication device supporting LTE-Wi-Fi aggregation (e.g., LTE-U, MuLTEFire, and the like), a first RAT may be either LTE or Wi-Fi, which both support data traffic, and a second RAT that is the other of LTE or Wi-Fi.

In an example, the first RAT may support data traffic (e.g., a TCP connection) and a second RAT may be take one or more communication resources away from the first RAT during certain periods of time. The second RAT may, for instance, periodically check for a paging signal from the CDMA2000 1× network. Checking for a paging signal may be considered a tuneaway event with respect to the transmissions pertaining to the first RAT. A tuneaway event may occur at scheduled time intervals and may last for a defined range of time (e.g., 30-100 milliseconds (ms)). In some instances, the first RAT may be unable to timely acknowledge a properly received TCP packet because resources of the communication device have been allocated to the second RAT. Because the TCP packets could not be timely acknowledged, a remote host may retransmit the TCP packets thus resulting in throughput loss and an unneeded retransmission.

Another type of radio impairment event may be associated with a communication device performing measurements on another frequency, or on another type of network. In such an example, some or all resources of the communication device (e.g., communication hardware) used to operate on a wireless wide area network (WWAN) may be temporarily borrowed to perform a measurement, thus impairing access to the WWAN. The measurement may comprise a wireless local area network (WLAN) measurement, such as active or passive scan, or a measurement for other RAT types such as WCDMA, CDMA2000, 1×EVDO, GSM, etc.

In another example, a radio impairment event may be unscheduled, but predictable, and optionally may not involve a communication device having a second RAT. Examples of unscheduled radio impairment events include a high error rate event (e.g., predict that a block error rate (BLER) will exceed a threshold), a handover event, and the like. In an example, a first RAT of a communication device may predict that a BLER will exceed a threshold based at least in part on a detected trend in an error rate, and may prevent the first RAT from timely acknowledging a properly received TCP packet. In another example, a first RAT may be instructed to perform a handover procedure which may prevent the first RAT from timely acknowledging a properly received TCP packet during the handover.

In an attempt to prevent a retransmission timeout for both scheduled and unscheduled radio impairment events, a communication device as described herein may rewrite a TCP timestamp, delay sending a TCP acknowledgement, or both, to influence a TCP retransmission timeout value of a remote host such that the TCP connection does not time out during the radio impairment event. In an example, a communication device may establish a transmission control protocol (TCP) connection with a remote host via a first radio access technology (RAT). The first RAT, for example, may provide access to an LTE network. The communication device may determine a time stamp value associated with traffic of the TCP connection. The communication device may adjust the time stamp value based at least in part on a radio impairment event that is scheduled or predicted to occur within a defined amount of time. A communication device, for example, may also support a second RAT (e.g., a CDMA2000 1× network) and may periodically monitor a paging signal from the CDMA2000 1× network. Monitoring for the paging signal may be considered a tuneaway event with respect to the transmissions pertaining to the first RAT and may require the communication device to allocate resources to the second RAT and away from the first RAT. In another example, the communication device may predict that an unscheduled radio impairment event will occur based at least in part on a BLER.

When a radio impairment event is to occur within a defined amount of time, the communication device may adjust a time stamp value in a TCP packet to induce an increase in retransmission timeout value calculated by a remote host. A larger timeout value may reduce the likelihood of a TCP connection timing out and prevent a remote host from retransmitting a TCP packet to the communication device that the communication device already correctly received. In another example, the communication device may delay sending an acknowledgment (ACK) TCP packet to induce an increase in the retransmission timeout value calculated by the remote host.

Aspects of the disclosure are initially described in the context of a wireless communications system that provides improved TCP-throughput for a concurrent RAT-capable communication device. Aspects of the disclosure are further illustrated by and described with reference to apparatus diagrams, system diagrams, and flowcharts that relate to mitigation of throughput degradation due to predictable radio impairment events.

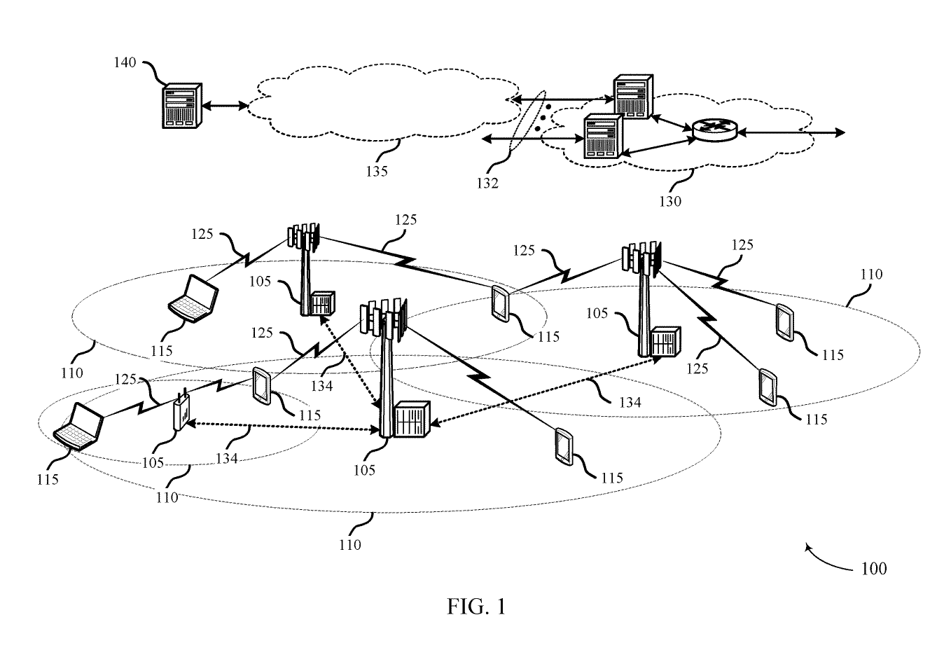

FIG. 1 illustrates an example of a wireless communications system 100 in accordance with various aspects of the present disclosure. The wireless communications system 100 includes base stations 105, communication devices 115, and a core network 130. In some examples, the wireless communications system 100 may be a LTE (or LTE-Advanced) network. Communication devices 115 may rewrite time stamps in TCP packets, may delay sending TCP acknowledgement packets, or both, to reduce the likelihood that a TCP connection times out during a radio impairment event.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include CDMA systems, TDMA systems, FDMA systems, and OFDMA systems. A wireless multiple-access communications system may include a number of base stations, each simultaneously supporting communication for one or more multiple communication devices.

Base stations 105 may wirelessly communicate with communication devices 115 via one or more base station antennas. Each base station 105 may provide communication coverage for a respective geographic coverage area 110. Communication links 125 shown in wireless communications system 100 may include uplink (UL) transmissions from a communication device 115 to a base station 105, or downlink (DL) transmissions, from a base station 105 to a communication device 115. Communication devices 115 may be dispersed throughout the wireless communications system 100, and each communication device 115 may be stationary or mobile. A communication device 115 may also be referred to as a mobile station, a user equipment (UE), a subscriber station, a remote unit, a wireless device, an access terminal (AT), a handset, a user agent, a client, or like terminology. A communication device 115 may also be a cellular phone, a wireless modem, a handheld device, a personal computer, a tablet, a personal electronic device, an MTC device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with communication devices 115, or may operate under the control of a base station controller (not shown). In some examples, base stations 105 may be macro cells, small cells, hot spots, or the like. Base stations 105 may also be referred to as eNodeBs (eNBs) 105.

An access point name (APN) may be the name of a gateway between a wireless network and another computer network 135 (e.g., the Internet). A communication device 115 making a data connection (as opposed to, e.g., a circuit switched voice connection) must be configured with an APN, which it conveys upon accessing the network. A server of the core network 130 may then examine the APN to determine what type of network connection should be created (e.g., what IP or IMS address should be assigned or what security methods should be used). In other words, the APN may identify a packet data network (PDN) that a communication device 115 wants to communicate with. In addition to identifying a PDN, an APN may also be used to define a service type (e.g., a wireless application protocol (WAP) server or multimedia messaging service (MMS)) that is provided by the PDN.

A base station 105 may be connected by an S1 interface to the core network 130. The core network may be an evolved packet core (EPC), which may include at least one MME, at least one S-GW, and at least one P-GW. The MME may be the control node that processes the signaling between the communication device 115 and the EPC. All user IP packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service (PSS).

Transmission Control Protocol (TCP) may be used to provide a reliable, ordered, and error-checked delivery of a stream of data between a communication device 115 and a remote host 140 via computer network 135 and core network 130. TCP may also support a connection between other devices, such as, e.g., a first communication device 115 to a second communication device 115, or any device supporting a TCP stack. The following describes a TCP connection established between remote host 140 and communication device 115 via computer network 135 and core network 130, but the TCP connection can be established between other devices that support TCP stacks and/or via other networks.

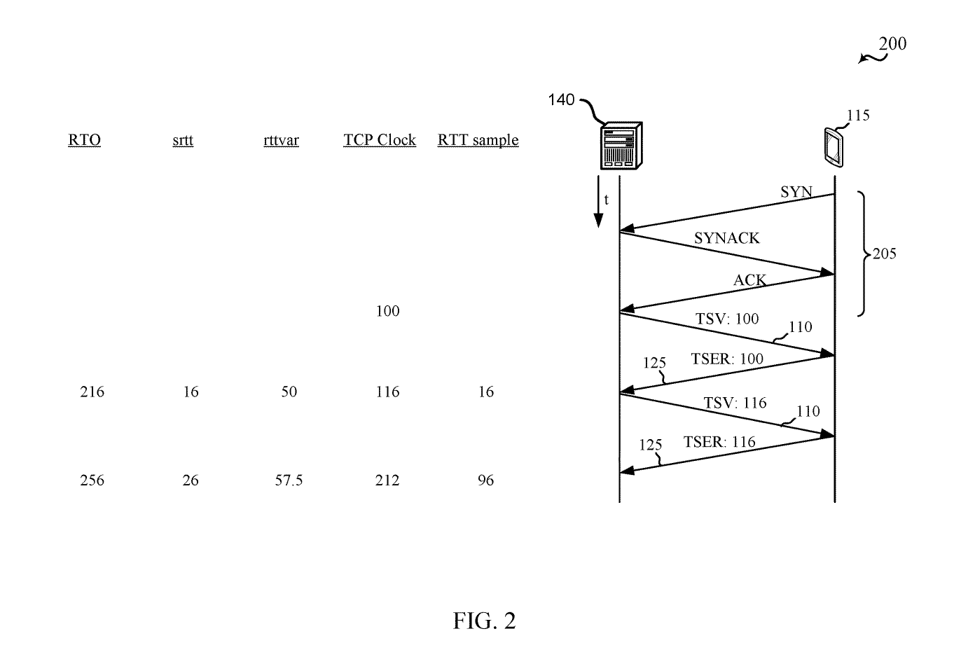

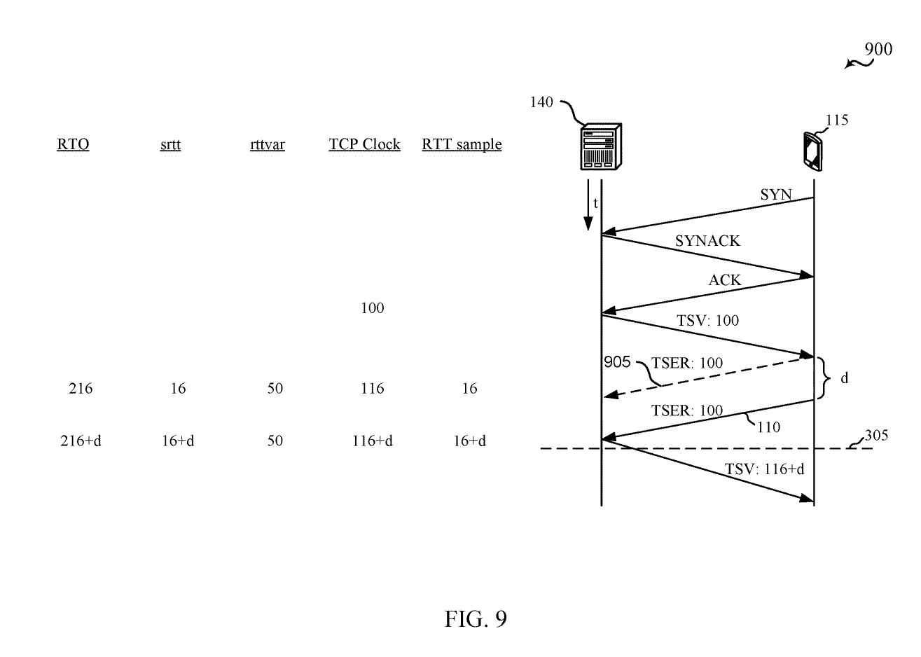

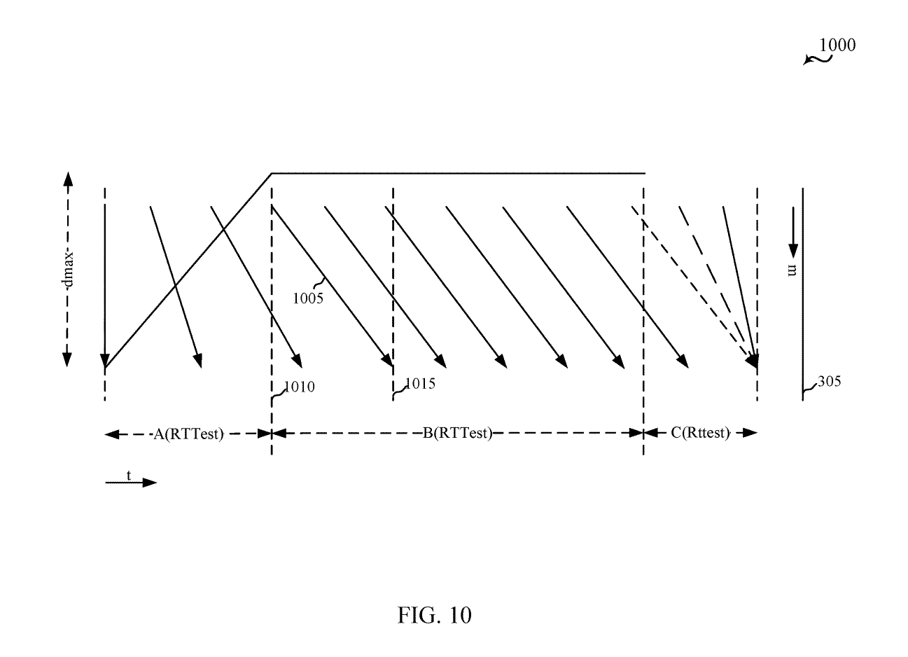

TCP can have relatively stringent requirements for TCP segment error rates, and this impact is even more significant as data rates increase. To achieve desired TCP segment error rates, packets may need to be retransmitted one or more times. For concurrent RAT-capable communication devices, a TCP connection may time out if a first RAT cannot send an acknowledgment within a defined amount of time after receipt of a TCP packet due to the communication device 115 allocating a resource away from the first RAT to a second RAT (e.g., allocate an antenna) in a scheduled radio impairment event. For concurrent RAT-capable and non-concurrent RAT-capable communication devices, the communication device 115 may predict that an unscheduled radio impairment event may occur within a defined amount of time (e.g., by monitoring an error rate and predicting when the error rate will exceed a threshold based at least in part on an error rate trend). To reduce the likelihood of a TCP timeout, the communication device 115 may induce a larger retransmission timeout value of the remote host 140 by rewriting timestamp values in TCP ACK packets or delaying sending the TCP ACK packets. FIGS. 2-8 below provide packet rewriting examples and FIGS. 9-10 below provide ACK delay examples.

FIG. 2 illustrates an example diagram 200 of TCP messages exchanged between a multimode communication device 115 and a remote host 140. In swim lane diagram 200, communications between the communication device 115 and a remote host 140 are shown on the right, and TCP parameters maintained by the remote host 140 are shown on the left. The TCP messages may be exchanged over a RAT supported by the communication device 115.

In this example, the communication device 115 and the remote host 140 may perform a three-way TCP handshake to establish a TCP connection. The TCP handshake is depicted as SYN/SYNACK/ACK TCP packets corresponding to brace 205. In the depicted example, the communication device 115 sends a SYN packet to the remote host 140. The SYN packet sets a sequence number of a TCP segment to a random number. In response, the remote host 140 replies with a SYN-ACK TCP packet. The SYN-ACK packet has an acknowledgment number set to one more than the received sequence number of the SYN packet and a sequence number that is another random number the remote host 140 selected for the SYN-ACK packet. To complete the three-way handshake, the communication device 115 sends an ACK TCP packet back to the remote host 140. The ACK packet includes a sequence number set to one more than the received acknowledgement value and the acknowledgement number set to one more than the received sequence number. After the three-way handshake is complete, a TCP connection is established between the communication device 115 and the remote host 140.

TCP protocol specifies that the remote host 140 retransmit TCP packets that have not been acknowledged within a defined amount of time, referred to as a retransmission timeout. The remote host 140 may maintain a TCP clock and various TCP parameters for determining when a retransmission timeout occurs. The TCP clock may indicate a current time associated with the TCP connection. Example TCP parameters are a retransmission time out (RTO) parameter, a round trip time (RTT) sample, a smoothed round trip time (SRTT) parameter, and a round trip time variation (rttvar) parameter. The remote host 140 generates the TCP parameters based at least in part on time stamp values included in headers of TCP packets communicated between the remote host 140 and the communication device 115. As seen in the swim lane diagram 200, at time 100, the remote host 140 generates and transmits a TCP packet having a time stamp value (TSV) of 100 based at least in part on the current time of the TCP clock. The communication device 115 receives the TCP packet, and generates and transmits an acknowledgment packet that includes the received TSV in a time stamp echo reply (TSER) field. The remote host 140, at time 116, receives the acknowledgment packet and calculates a value for the RTT sample parameter as a function of the current time of the TCP clock and the value in the TSER field. Below is an example formula for calculating the RTT sample:

RTT sample=current time−TSER

In the depicted example, the RTT sample is 16 (e.g., 116−100=16).

The remote host 140 calculates the srtt value as a function of the current RTT sample and a previous value of srtt. The remote host 140 uses the calculation to smooth out fluctuations in the current value of the RTT sample. Below is an example formula for calculating srtt:

srtt=(7/8)*srtt+(1/8)*(RTT sample)

The remote host 140 also calculates rrtvar, which is a measure of how much RTT varies over time. Below is an example formula for calculating rrtvar:

rttvarᵢ=rttvarᵢ₋₁+(1/4)*(|(RTT sample)−srtt|−rttvarᵢ₋₁)

where rttvar₁ corresponds to the calculation of a current value of rttvar and rttvarᵢ₋₁ corresponds to the preceding value of rttvar.

The remote host 140 may calculate the value of the RTO parameter as a function of srtt and rttvar. RTO is the amount of time the remote host 140 waits to receive a packet from the communication device 115 after transmitting a TCP packet to the communication device 115 before retransmitting the same TCP packet. Below is an example equation for calculating RTO:

RTO set=max(srtt+4*rttvar,200)

In the example equation, RTO is the greater of srtt+4*rttvar and 200 milliseconds (ms). Values other than 200 ms may be used.

In some instances, the communication device 115 concurrently operates multiple radio access technologies (RATs) that share a common resource of the communication device 115. For example, a first RAT may provide the communication device 115 with access to an LTE network and a second RAT may provide the communication device 115 with access to a CDMA2000 1× network. The common resource may be, for example, one or more antennas that are allocated to one of the RATs during a time period, while the other RATs are prevented from using the common resource during the time period. The communication device 115 may control when the RATs can access the common resource. A radio impairment event may occur when one of the RATs has information to communicate but is prevented from doing so because another RAT has access to the common resource. A tuneaway event is an example of a radio impairment event. A tuneaway event may occur, for example, when the communication device checks to see if a page is sent from a CDMA2000 1× network. Page monitoring may be required for the communication device to be able to make or receive calls over the CDMA2000 1× network.

In some instances, the communication device 115 may or might not concurrently operate multiple radio access technologies (RATs). Either way, the communication device 115 may monitor an error rate (e.g., BLER) of TCP packets sent via a TCP connection or for instructions to perform a handover. Detecting an error rate that satisfies (e.g., exceeds, meets or exceeds, etc.) a threshold (or is likely to satisfy a threshold based at least in part on an error rate trend) and/or being instructed to perform a handover may be considered an unscheduled radio impairment event that may prevent a RAT from timely acknowledging a properly received TCP packet.

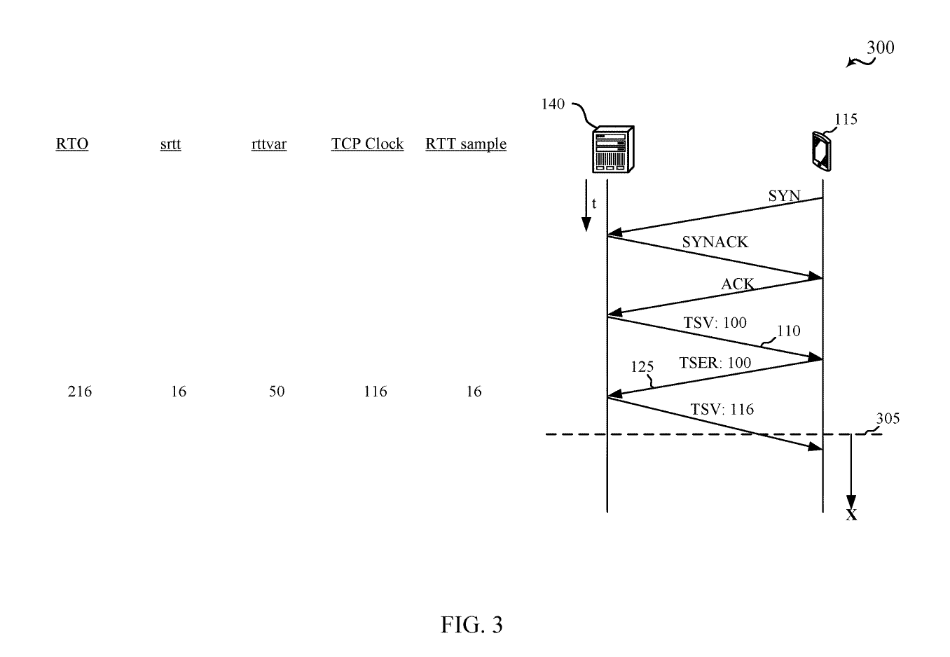

FIG. 3 illustrates an example of a swim lane diagram 300 for mitigation of throughput degradation due to predictable radio impairment events. In the depicted example, the remote host 140 and communication device 115 may undergo the three-way TCP handshake as in FIG. 2. At time 116, the remote host 140 may communicate a TCP packet having a TSV of 116. Before acknowledging the TCP packet, the communication device 115 may experience a radio impairment event, represented by dashed line 305. The radio impairment event may be scheduled or may be unscheduled but predicted to occur. At a time corresponding to line 305, the communication device 115 may allocate a subset of resources (e.g., one or more antennas) to the second RAT for monitoring for a paging signal from a CDMA2000 1× network. During this time, the first RAT may be prevented from accessing the resources and hence unable to send an ACK packet in response to the TCP packet. In another example, the communication device 115 may be prevented from using the first RAT to acknowledge a TCP packet due to a handover or unable to reliably transmit due to the error rate. If the sum of the duration of the radio impairment event and the round trip time between the communication device 115 and remote host 140 exceeds the value of RTO, then the remote host 140 may determine that an RTO has occurred and retransmit the TCP packet. An RTO is represented by the depicted “x”. In the depicted example, a value of the RTO parameter is 216 ms and this value may be determined using the formulas above.

In many situations, however, the communication device 115 may know when the radio impairment event is scheduled or predicted to occur and an approximate duration of the radio impairment event. The communication device 115 may then attempt to increase the RTT of the remote host 140 that is used to calculate the value of an RTO timeout so that the RTO transmission timer is less likely to expire during the radio impairment event. In some examples, a duration of the radio impairment event may be within a defined range of time. The following provides examples of scheduled and unscheduled radio impairment events, and calculating a defined range of time to approximate the duration of a radio impairment event.

In an example, a tuneaway event is scheduled at periodic intervals and lasts for a defined range of time. A duration of the tuneaway may depend on the duration of a page transmission for the second RAT, the time to tune a radio to a target frequency of the second RAT and back to a source frequency of the first RAT, and the time to reconfigure modem hardware and software to operate the second RAT. The communication device 115 may determine the duration of the transmission of the page according with a specification corresponding to a network associated with the second RAT (e.g., duration of a transmission time interval (TTI) number of TTI for the transmission of a page, time required to acquire the system, etc.). The total duration of a tuneaway for a CDMA2000 1× network may be 120 ms and the total duration for a GSM network may be 50 ms. Other networks may have other total durations. The communication device 115 may influence the remote host 140 to increase RTT by the total duration corresponding to the network used by the second RAT to prevent an RTO transmission timeout during the tuneaway event. In some examples, the total duration of a tuneaway period may be random, and not deterministic. The total duration may be an upper bound of a defined range of time of an approximated duration of the tuneaway event.

Another type of radio impairment event may be associated with a communication device performing measurements on another frequency, or on another type of network. In such an example, some or all resources of the communication device 115 used to operate on a wireless wide area network (WWAN) may be temporarily borrowed to perform a measurement, thus impairing access to the WWAN. The measurement may comprise a wireless local area network (WLAN) measurement, such as active or passive scan, or a measurement for other RAT types such as WCDMA, CDMA2000, 1×EVDO, GSM, etc. The communication device 115 may perform the WLAN measurement or scan during a single time period, where a list of available channels are scanned one after the next, in which case the interruption time is longest and may reach seconds. In this case, the communication device 115 may influence a TCP retransmission timeout value of a remote host by increasing RTT by seconds. Alternatively or additionally, the scan may be separated into a plurality of sub-scans, such as scanning two channels, then returning to a serving channel, etc. In this case the amount of RTT increase is proportional to the interruption associated with scanning two channels (e.g., 60 ms).

In other examples, the radio impairment event may be unscheduled, but predictable. For example, during wireless wide area network (WWAN) data transfer a nominal RTT may be low and have low variance. When a radio impairment event occurs the TCP connection may be operating with a small RTO value. In some instances, the communication device 115 may be able to reliably predict the future occurrence of an unscheduled radio impairment event. A first type of impairment is associated with an increased transmission error rate. The communication device 115 may predict an increased transmission error rate based at least in part on observed parameters. Examples of observed parameters may include: a trend of degradation of pilot power or pilot quality; an increasing trend of the average number hybrid automatic repeat request (HARQ) transmissions; a decreasing trend on Channel Quality Indication (CQI) feedback; use of a reduced transmission or reception rate (e.g., MCS); any combination thereof, and the like. The communication device 115 may predict when an error rate will exceed an error rate threshold based at least in part in a trend in one or more of the observed parameters.

When an unscheduled radio impairment event is predicted to occur, the communication device 115 may influence the remote host 140 to increase RTT based at least in part on the amount of time to recover packets using an impaired communication link. In an example the amount to increase RTT may be proportional to the amount of time required for a HARQ or ARQ operation to recover a packet with high probability on an impaired link. For HARQ with asynchronous operation, a communication device 115 may account for four transmissions spaced by a defined amount of time each (e.g., 12 ms each). For ARQ the communication device 115 may compute the amount of time required to report an error using ARQ. The amount of time may be based at least in part on a direction of a radio link control (RLC) status prohibit timer, a duration of a RLC reordering timer, and a duration of time for the communication device to perform retransmission. For example, for a 40 ms prohibit timer, a 60 ms reordering timer, and a 20 ms to perform retransmission, the communication device 115 may increase the RTT by a total duration of 120 ms when the communication device 115 predicts an ARQ operation will be used. The total duration may be an upper bound of a defined range of time of an approximated duration of the amount of time to recover packets using an impaired communication link. The amount of time to recover packets using an impaired communication link may also include other timers such as, for example, a Packet Data Convergence Protocol (PDCP) timer or a HARQ timer, and hence these additional timers may be used to influence RTT of the remote host 140.

Another type of unscheduled radio impairment event is a handover from one cell to another. The communication device 115 may influence the RTT of remote host 140 based at least in part on the amount of time to complete the handover. In an example, the communication device 115 may predict the occurrence of the handover using one or more measurements. Example measurements may include a strength of serving cell's signal relative to a strength of a neighbor cell's signal (e.g., signal of serving cell is decreasing and signal of neighbor cell is increasing). The communication device 115 may also predict occurrence of handover based at least in part on processing a measurement report indicating one or more network conditions, receiving a handover command from the network, and the like. The total duration for the amount of time to increase RTT may be based at least in part on the interruption time incurred by a handover, and may include: the time to acquire a target cell (e.g., 10 ms in LTE); the time to perform an access procedure (e.g., 50 ms in LTE to perform a random access procedure), the time to re-establish a radio connection (e.g., 20 ms in LTE), and the time to forward traffic from a source evolved Node B (eNB) to a target eNB (e.g., 30 ms in LTE), which may sum to 110 ms for an LTE system. The total duration may be an upper bound of a defined range of time of an approximated duration of the handover.

To reduce the likelihood of an RTO timeout and prevent the remote host 140 from sending an unnecessary retransmission due to a scheduled or unscheduled radio impairment event, the communication device 115 may rewrite a value of the TSER in ACK packets sent to the remote host 140 to artificially increase the value of the RTO parameter based at least in part on a defined range of time for the duration of the radio impairment event.

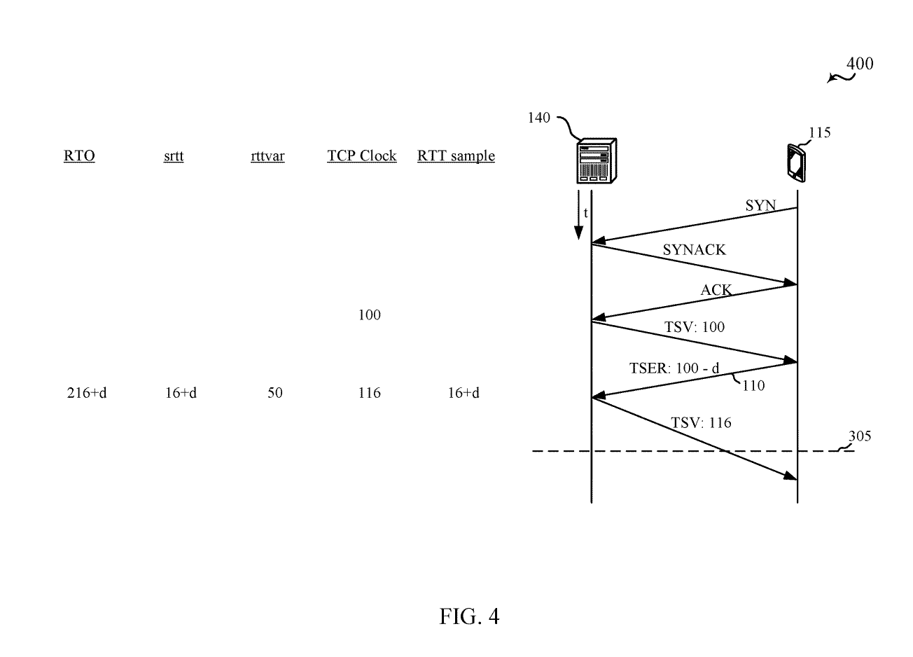

FIG. 4 illustrates an example swim lane diagram 400 for mitigation of throughput degradation due to predictable radio impairment events. The communication device 115 may rewrite the TSER in an ACK packet to adjust the RTO parameter of the remote host 140. As depicted, the remote host 140 sends a TCP packet having a TSV of 100 to the communication device 115. The communication device 115 receives the TCP packet, reads the value of TSV (e.g., 100), and adjusts the value by amount d (e.g., reduces TSV by d). The amount d may be a defined amount, may depend on how much time there is before the radio impairment event, may be based at least in part on a defined range of the duration of the radio impairment event (e.g., an upper bound of the duration of the radio impairment event), may be based at least in part on a duration of a round trip time between the remote host 140 and communication device 115, may be based at least in part on clock granularity (as described below), any combination thereof, or the like. The communication device 115 generates and transmits an acknowledgment packet with a TSER having the adjusted value of the TSV (e.g., 100−d), instead of the value of TSV from the received TCP packet. The remote host 140 receives the acknowledgment packet, reads the value of TSER (e.g., 100−d), and sets the RTT sample parameter to the received TSER value. Using the formulas above, the remote host 140 calculates srtt and the RTO. As can be seen, the remote host 140 calculates a larger value for srtt (e.g., 16+d) and RTO set (e.g., 216+d) due to the adjusted TSV. In this example, an RTO timeout does not occur so long as the sum of the duration of the radio impairment event and a duration of the round trip time between the remote host 140 and communication device 115 does not exceed 216+d.

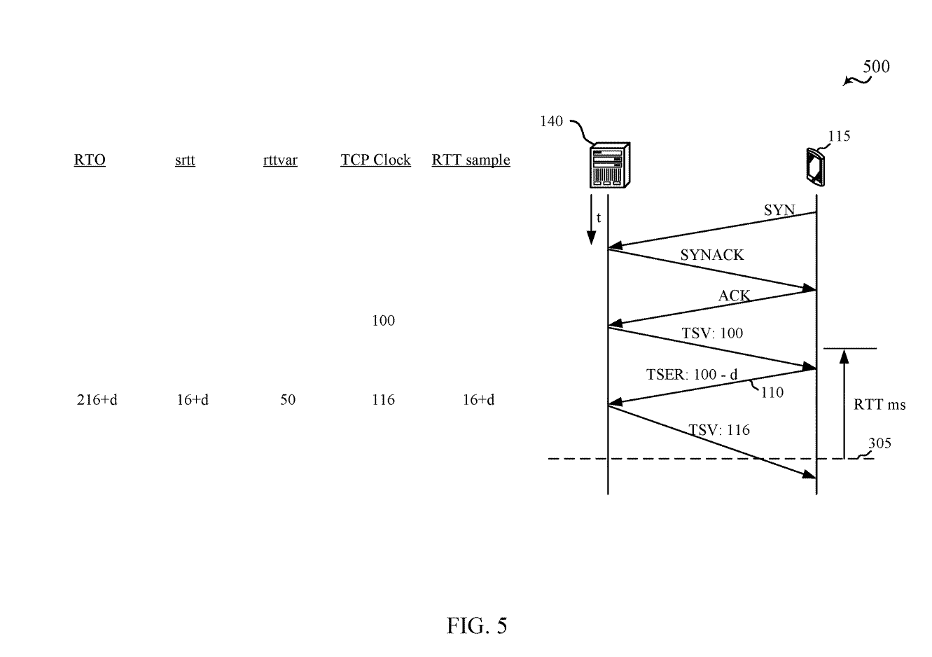

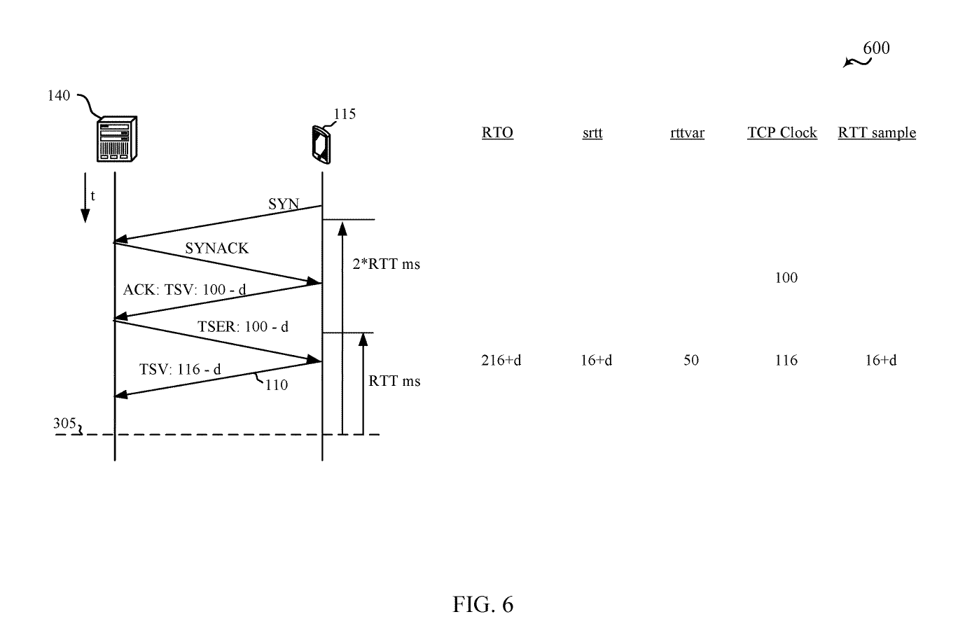

In some examples, the communication device 115 may not adjust the TSV for every received TCP packet, and instead may limit adjusting the TSV when within a defined amount of time of the scheduled or predicted radio impairment event. FIG. 5 depicts adjusting the TSER for downlink TCP packets and FIG. 6 depicts adjusting the TSV for uplink TCP packets.

FIG. 5 illustrates an example swim lane diagram 500 for mitigation of throughput degradation due to predictable radio impairment events. The communication device 115 may adjust the TSV for acknowledging a downlink TCP packet when a radio impairment event is scheduled or predicted to occur within a defined amount of time. In the depicted example, the defined amount of time is the round trip time between the remote host 140 and communication device 115. In this example, the communication device 115 may estimate the round trip time using, for example, a statistical measure of the round trip time (e.g., average). When a radio impairment event is not scheduled or predicted to occur within an RTT of when a TCP packet is received, the communication device 115 may respond to the TCP packet with an ACK packet where the TSER value is the same as the TSV of the TCP packet. When a radio impairment event is scheduled or predicted to occur within an RTT of when a TCP packet is received, the communication device 115 may adjust the value of the TSV received in a downlink TCP packet. In the depicted example, the TSV value is reduced by amount d and the adjusted value is included in the TSER of the ACK packet.

FIG. 6 illustrates an example swim lane diagram 600 for mitigation of throughput degradation due to predictable radio impairment events. The communication device 115 may adjust the TSV when a tuneaway event is scheduled or predicted to occur within a multiple of a round trip time (e.g., 2*RTT) between the remote host 140 and communication device 115 relative to when an uplink TCP packet is to be sent.

The communication device 115 may adjust the TSV in an uplink TCP packet when a radio impairment event is scheduled or predicted to occur within a defined amount of time. In the depicted example, the defined amount of time is a multiple of the round trip time between the remote host 140 and communication device 115 (e.g., 2*RTT). When a radio impairment event is not scheduled or predicted to occur within a multiple of RTT of when a TCP packet is to be sent, the communication device 115 may send an uplink TCP packet where the TSV is based at least in part on the current time measured by a TCP clock of the communication device 115.

When a radio impairment event is scheduled or predicted to occur within a multiple of RTT of when the TCP packet is to be sent (e.g., 2*RTT), the communication device 115 may adjust the value of the TSV sent in an uplink TCP packet. In the depicted example, the communication device 115 determines a current value of the TCP clock (e.g., 100), adjusts the value by amount d, and sets TSV in the uplink TCP packet to the adjusted value (e.g., 100−d). The communication device 115 adjusts TSV earlier for uplink TCP packets than downlink TCP packets to give a local operating system (OS) of the communication device 115 time to adjust the RTO before the radio impairment event occurs. If, for example, the communication device 115 waited to adjust uplink TCP packets (e.g., within RTT), the scheduled or predicted radio impairment event would occur before the local OS could calculate the RTO, and hence adjusting the TSV would not have the desired impact of artificially increasing RTO prior to the radio impairment event. In another example, the communication device 115 may rewrite every TSV, and not just when a radio impairment event is scheduled or predicted to occur within a multiple of RTT of when the TCP packet is to be sent.

One issue with TCP connections is that clock granularity may differ between clocks maintained by the remote host 140, a modem of the communication device 115, and a local operating system (OS) of the communication device 115. The local OS may be a high level OS. In one example, clock granularity may refer to how many times a clock increments per second. For example, a clock of the remote host 140 may increment 1000 times per second, the modem clock may increment 2000 times per second, and the local operating system of the communication device 115 may increment 1500 times per second. The communication device 115 may use its modem clock as a reference clock, and may determine clock granularity relative to each of the remote host clock and the local OS clock. The communication device 115 may use the determined clock granularities for adjusting TSV and TSER included in the TCP packets.

The communication device 115 may determine the clock granularity unit at the remote host 140 relative to the modem for downlink traffic. The determined clock granularity unit may be performed for every downlink TCP packet the modem receives from the remote host 140. Similarly, the communication device 115 may determine the clock granularity unit at the local OS of the communication device 115 relative to the modem for uplink traffic. The determined clock granularity unit may be performed for every uplink TCP packet the modem receives from the OS.

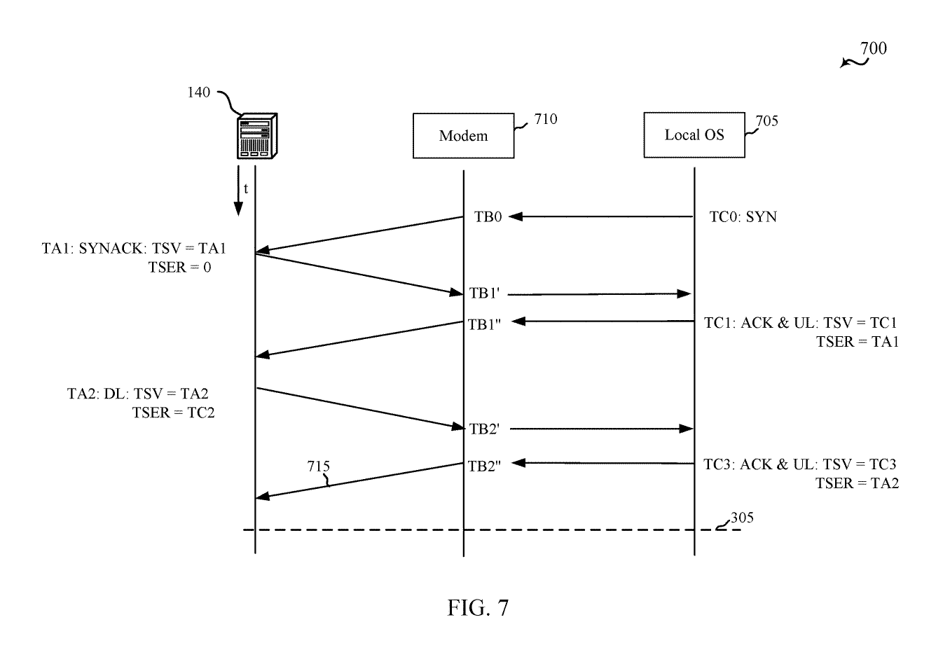

FIG. 7 illustrates an example swim lane diagram 700 for mitigation of throughput degradation due to predictable radio impairment events. The modem 710 of the communication device 115 may use its clock to track the times when TCP packets are received from each of the remote host 140 and local OS 705 of communication device 115, as well as TSV and/or TSER values included in the received TCP packets, for determining clock granularity.

In an example, when communication device 115 initiates a TCP connection with the local OS 705 generating the TCP SYN packet. The local OS 705 may pass the SYN packet to the modem 710 of the communication device 115. The modem 710 may transmit the SYN packet to the remote host 140. The remote host 140 may determine the current time using its remote host clock (e.g., TA1), and generate a TCP SYNACK packet having the TSV value of the current time and a time stamp echo reply (TSER) value of zero. The remote host 140 may transmit the SYNACK packet to the communication device 115. The modem 710 may forward the SYNACK packet to the local OS 705, which may determine the current time using the local OS clock (e.g., TC1). The local OS 705 may generate a TCP ACK packet having a time stamp value with the current time (e.g., TC1) and a TSER value corresponding to the TSV of the received SYNACK packet (e.g., TA1). The local OS 705 may send the TCP ACK packet to the modem 710 for transmission to the remote host 140. The modem 710 may determine the time at which the packet is received from the remote host (TB1′) and the time at which the ACK packet is received from the local OS 705 using its modem clock (e.g., TB1″) and transmit the ACK packet to the remote host 140. The remote host 140 may determine the time at which the ACK packet is received using its remote host clock (e.g., TA2). The remote host 140 may generate a TCP packet with a time stamp value for the current time using the remote host clock (e.g., TA2) and the TSER value corresponding to the TSV from the last TCP packet received from the communication device 115 (e.g., TC2). The remote host 140 may transmit the TCP packet to the communication device 115. The modem 710 may forward the TCP packet to the local OS 705. The local OS 705 may determine the current time using the local OS clock (e.g., TC3). The local OS 705 may generate a TCP ACK packet having a TSV of the current time (e.g., TC3) and a TSER value corresponding to the TSV of the received TCP packet (e.g., TA2). The local OS 705 may send the TCP ACK packet to the modem 710 for transmission to the remote host 140. The modem 710 may determine the time at which the packet is received from the remote host (e.g., TB2′) and the time at which the ACK packet is received from the local OS 705 using its modem clock (e.g., TB2″) and transmit the ACK packet to the remote host 140.

The communication device 115 may use the timing values from the swim lane diagram 700 for estimating a clock unit of remote host 140 and local OS of the communication device 115 relative to a reference time determined by modem 710.

In an example, the communication device 115 may estimate the clock unit at the remote host for downlink traffic based at least in part on TSVs read from downlink packets and the current time on the modem clock at which the downlink packets are received. The communication device 115 may update the clock unit estimate for every received downlink packet. In an example, the communication device 115 may estimate the clock unit of the remote host 140 using the following equation:

Relative remote host clock unit=(TA2−TA1)/(TB2′−TB1′),

where TA1 is the TSV of downlink SYNACK received at TB1′, and TA2 is the TSV of latest downlink ACK received at TB2′. The communication device 115 may use the relative remote host clock unit for determining an amount of time to adjust a time stamp value based at least in part on the clock granularity and for translating the determined amount of time into a time unit of the remote host.

The communication device 115 may also estimate the clock unit at the local OS 705 for uplink traffic based at least in part on TSVs read from uplink packets and the current time on the modem clock at which the uplink packets are received. The communication device 115 may update the estimate for every received uplink packet. In an example, the communication device 115 may estimate the clock unit using the following equation:

Relative local OS clock unit=(TC3−TC1)/(TB2″−TB1″),

wherein TC1 is the TSV of uplink ACK to SYNACK received at TB1″, and TC3 is the TSV of the latest uplink packet received at TB2″. The communication device 115 may use the relative local OS clock unit for determining an amount of time to adjust a time stamp value based at least in part on the clock granularity and for translating the determined amount of time into a time unit of the local OS of the communication device.

As seen in FIG. 7, each of the clock unit estimates may be determined prior to a next scheduled or predicted radio impairment event 305.

The communication device 115 may use the relative remote host clock unit for estimating a round trip time (RTTest) between the communication device 115 and the remote host 140 to account for clock granularity. In an example, the communication device 115 may estimate the clock unit using the following equation:

RTTest=[TB2′−TC2/(Relative local OS clock unit)]

For a certain period of time prior to the radio impairment event, the communication device 115 may determine the amount of time to adjust the TSV (2*RTTest prior to the radio impairment event) and the TSER (RTTest prior to the radio impairment event) in outgoing TCP packets based at least in part on the determined clock granularities of the remote host and the local OS of the communication device. In an example, the communication device 115 may reduce both TSVs and TSERs in outgoing packets from local OS 705 to remote host 140 using the following equations:

TSVreduced=[TSV−d*(Relative local OS clock unit)]=[TSV−d*(TC3−TC1)/(TB2″−TB1″)],

TSERreduced=[TSER−d*(Relative remote host clock unit)]=[TSER−d*(TA2−TA1)/(TB2′−TB1′)],

where d is a defined delay. After rewriting TSER and TSV, the communication device 115 may adjust the TCP packet for wraparound and recompute a checksum in a TCP header of the TCP packet. In this example, the TCP packet corresponding to line 715 and may include TSVreduced and TSERreduced.

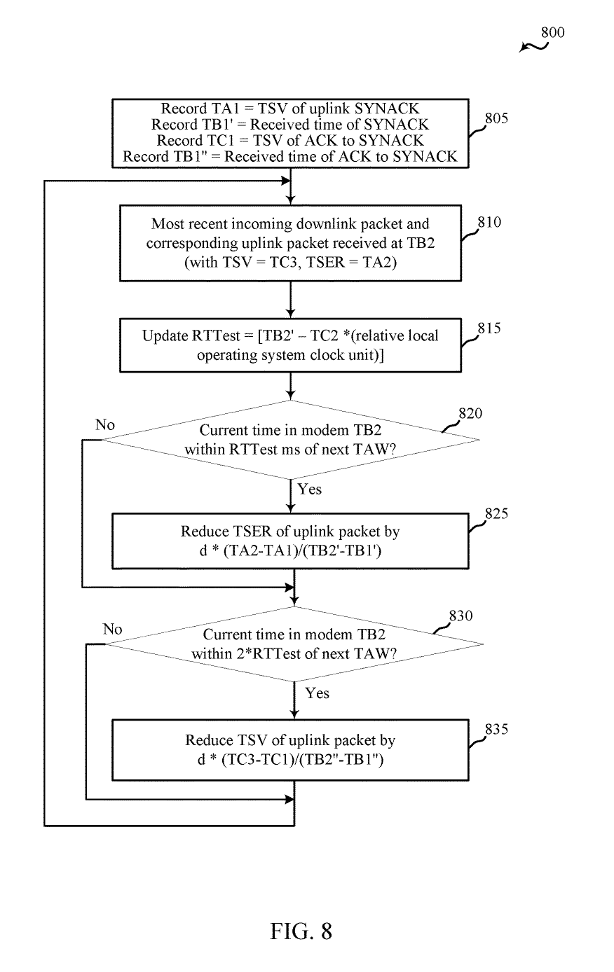

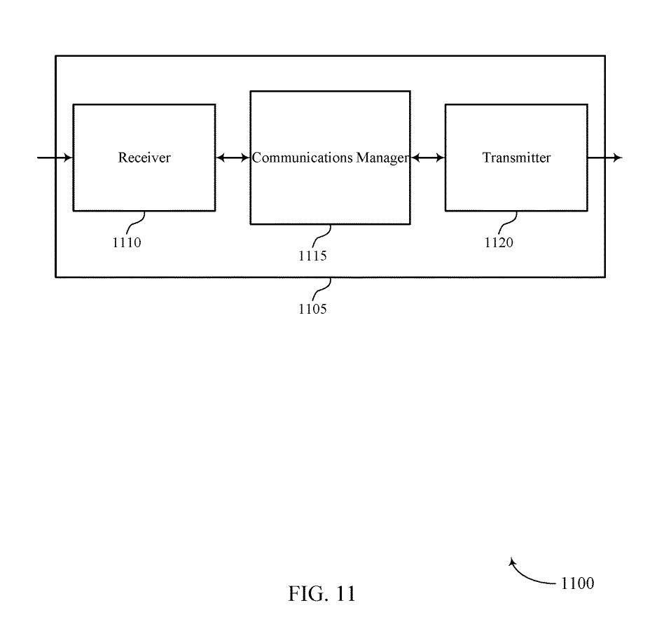

FIG. 8 illustrates a flowchart illustrating a method 800 for mitigation of throughput degradation due to predictable radio impairment events. The operations of method 800 may be implemented by a communication device 115 or its components as described herein. For example, the operations of method 800 may be performed by a communications manager as described with reference to FIGS. 11 through 14. In some examples, a communication device 115 may execute a set of codes to control the functional elements of the device to perform the functions described below. Additionally or alternatively, the communication device 115 may perform aspects the functions described below using special-purpose hardware.

In block 805, the method 800 may include recording times when TCP packets are received and a TSV and/or a TSER of the received TCP packets. For example, the communication device 115 may record TA1 from the TSV of downlink SYNACK, record TB1′ corresponding to a received time of SYNACK at the modem 710, record TC1 from the TSV of ACK to SYNACK, and record TB1″ from the received time of ACK to SYNACK.

In block 810, the method 800 may include the communication device 115 receiving a most recent an incoming downlink TCP packet at TB2′ and a corresponding uplink packet received at time TB2″ on the modem clock, having a TSV of TC3 and a TSER of TA2.

In block 815, the method 800 may include the communication device 115 updating an estimate of RTT (RTTest). For example, the communication device 115 may update RTTest using the following equation:

RTTest=[TB2′−TC2/(Relative local OS clock unit)]

In block 820, the method 800 may include determining whether a current modem time is within a defined amount of time of the next radio impairment event. For example, the communication device 115 may determine whether a current modem time is within RTTest of the next tuneaway (TAW) event. If no, the method 800 may proceed to block 830. If yes, the method 800 may proceed to block 825.

In block 825, the method 800 may include reducing the TSER of an uplink packet. For example, if the TSER is TA2, the communication device 115 may apply the following equation to determine TSERreduced:

TSERreduced=TA2−d*(TA2−TA1)/(TB2′−TB1′)

Where d is a defined time delay and TA2, TA1, TB2′, and TB1′ are discussed above in FIG. 7. The communication device 115 thus determines an amount of time to adjust the time stamp value based at least in part on the clock granularity and translates the determined amount of time into a time unit of the remote host.

In block 830, the method 800 may include determining whether a current modem time is within a multiple of defined amount of time of the next radio impairment event. For example, the communication device 115 may determine whether a current modem time is within 2*RTTest of the next TAW event. If no, the method 800 may proceed to block 810. If yes, the method 800 may proceed to block 835.

In block 835, the method 800 may include reducing the TSV of an uplink packet. For example, if TSV is TC2, the communication device 115 may apply the following equation to determine TSVreduced:

TSERreduced=TC3−d*(TC3−TC1)/(TB2″−TB1″)],

Where d is a defined time delay and TC3, TC1, TB2″, and TB1″ are discussed above in FIG. 7. The communication device 115 thus determines an amount of time to adjust the TSER based at least in part on the clock granularity and translates the determined amount of time into a time unit of the local OS of the communication device.

As part of reducing TSV and/or TSER, the communication device 115 may adjust the TCP packet for wraparound and recompute a checksum in TCP headers of the outgoing packets.

The method 800 may return to block 810 and may repeat one or more times.

In addition to or instead of rewriting a time stamp, the communication device 115 may delay sending an ACK TCP packet to induce a larger value of RTO. FIG. 9 illustrates an example swim lane diagram 900 for mitigation of throughput degradation due to predictable radio impairment events.

The communication device 115 may delay sending every ACK packet or only delay sending ACK packets when scheduled to send an ACK packet within a defined time period relative to a radio impairment event 305. As depicted, the remote host 140 and communication device 115 may perform a TCP handshake as discussed above. In this example, the remote host 140, at time 100, sends a TCP packet with a TSV of 100. Rather than timely responding to the TCP packet (see dashed line 905 in swim lane diagram 900), the communication device 115 delays sending the acknowledgement packet for a defined amount of time d (e.g., d=80 ms). The communication device 115 may calculate the duration of delay d or delay d may be defined. For example, the amount d may depend on how much time there is before the radio impairment event, may be based at least in part on a defined range of the duration of the radio impairment event (e.g., an upper bound of the duration of the radio impairment event), may be based at least in part on a duration of a round trip time between the remote host 140 and communication device 115, may be based at least in part on clock granularity (as described below), any combination thereof, or the like. After determining that at least the duration of delay d has expired, the communication device 115 may send the ACK packet with the TSER having the same TSV as received in the TCP packet (e.g., 100). Because transmission of the ACK packet was intentionally delayed, the remote host 140 receives the ACK packet at a later time due to the delay and calculates the value of the RTO parameter accounting for delay d using the formulas above. Here, the value of the RTO parameter is increased by delay d (e.g., 216+d). In some examples, the delay d may be used to delay transmission of a TCP acknowledgment packet to a lower radio layer. In some examples, the delay d may be used to delay reception of a TCP acknowledgment packet by an upper radio layer.

In some examples, the communication device 115 may calculate the duration of delay d based at least in part on how much time there is before the radio impairment event. FIG. 10 illustrates an example chart 1000 for mitigation of throughput degradation due to predictable radio impairment events. The chart 1000 may represent how the communication device 115 calculates the duration of delay d. In the depicted example, a time axis t may proceed from left to right. The communication device 115 may calculate the duration of the delay d based at least in part on how much time there is between a current time and the scheduled or predicted time of the radio impairment event. The amount of time before the scheduled or predicted time may correspond to three time regions A, B, and C, and the calculated delay duration may range from zero to dmax. The arrows (e.g., see arrow 1005) may represent the amount an ACK packet is delayed. For arrow 1005, dashed line 1010 may represent when the time when a modem of the communication device 115 receives an ACK, and dashed line 1015 may represent the time when the modem transmits the ACK to the remote host 140.

The duration of time region A may be a function of an estimated RTT (RTTest) and the delay may linearly increase across region A from 0 to dmax. The duration of time region B may be a function of RTTest and the calculated delay duration may be constant value of dmax in region B. The duration of time region C may be a function of RTTest. In time region C, the communication device 115 may hold all ACK packets and submit only a last one at a defined amount of time before the next scheduled or predicted radio impairment event. In another example, the communication device 115 may, in time region C, linearly decrease the delay from dmax to zero and release all ACKs before the next scheduled or predicted radio impairment event. To do so, the communication device 115 may decimate and transmits the ACKs before the radio impairment event to avoid the RTO from timing out. Decimating the ACKs may involve creating a consolidated ACK packet that includes information corresponding to multiple TCP packets received over the TCP connection. After time region C, the communication device 115 may transmit the consolidated TCP acknowledgement packet at a fixed amount of time m prior to the radio impairment event. The fixed amount of time m may be considered as a margin prior to the next scheduled or predicted radio impairment event for overhead involved with switching from one RAT to another. (e.g., TAW overhead on LTE network).

Clock granularity as described above with reference to FIGS. 7-8 may similarly apply when the communication device 115 calculates the duration of delay d for delaying an ACK packet.

Thus, the communication device 115 may rewrite time stamp values, delay sending ACKs, or a combination thereof, to influence a larger RTO parameter of the remote host 140 and to reduce the likelihood of an RTO during a radio impairment event.

FIG. 11 shows a block diagram 1100 of a wireless device 1105 that supports mitigation of throughput degradation due to predictable radio impairment events in accordance with various aspects of the present disclosure. Wireless device 1105 may be an example of aspects of a communication device 115 as described with reference to FIG. 1. Wireless device 1105 may include receiver 1110, communications manager 1115, and transmitter 1120. Wireless device 1105 may also include a processor. Each of these components may be in communication with one another (e.g., via one or more buses).

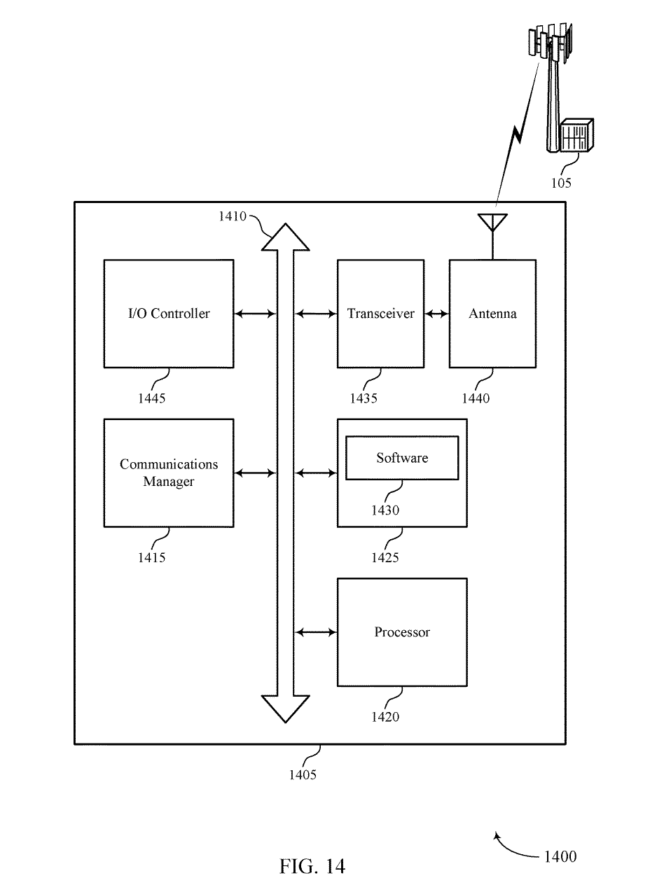

Receiver 1110 may receive information such as packets, user data, or control information associated with various information channels (e.g., control channels, data channels, and information related to mitigation of throughput degradation due to predictable radio impairment events, etc.). Information may be passed on to other components of the device. The receiver 1110 may be an example of aspects of the transceiver 1435 described with reference to FIG. 14.

Communications manager 1115 may be an example of aspects of the communications manager 1415 described with reference to FIG. 14.

Communications manager 1115 may establish a transmission control protocol (TCP) connection with a remote host via a first RAT, determine a time stamp value associated with traffic of the TCP connection, and adjust the time stamp value based at least in part on a radio impairment event, where the radio impairment event is scheduled or predicted to occur within a defined amount of time. The communications manager 1115 may also establish a transmission control protocol (TCP) connection with a remote host via a first RAT, determine that a radio impairment event is scheduled or predicted to occur within a defined amount of time, determine a duration of a delay based at least in part on a defined range of time of the radio impairment event, and delay communicating a TCP acknowledgement packet over the TCP connection by at least the duration of the delay.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1435 described with reference to FIG. 14. The antenna 1440 may include a single antenna, or it may include a set of antennas.

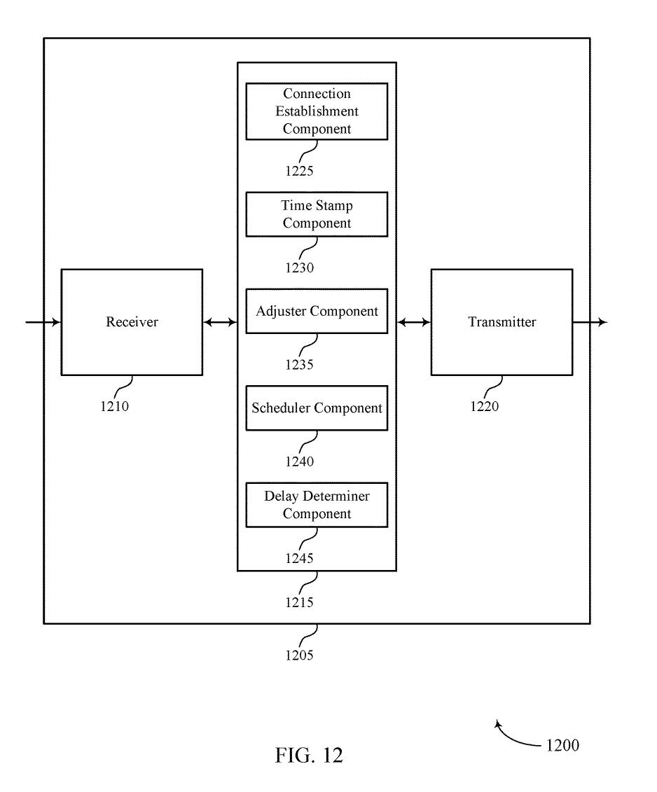

FIG. 12 shows a block diagram 1200 of a wireless device 1205 that supports mitigation of throughput degradation due to predictable radio impairment events in accordance with various aspects of the present disclosure. Wireless device 1205 may be an example of aspects of a wireless device 1105 or a communication device 115 as described with reference to FIGS. 1 and 11. Wireless device 1205 may include receiver 1210, communications manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to mitigation of throughput degradation due to predictable radio impairment events, etc.). Information may be passed on to other components of the device. The receiver 1210 may be an example of aspects of the transceiver 1435 described with reference to FIG. 14.

Communications manager 1215 may be an example of aspects of the communications manager 1415 described with reference to FIG. 14.

Communications manager 1215 may also include connection establishment component 1225, time stamp component 1230, adjuster component 1235, scheduler component 1240, and delay determiner component 1245.

Connection establishment component 1225 may establish a transmission control protocol (TCP) connection with a remote host via a first RAT.

Time stamp component 1230 may determine a time stamp value associated with traffic of the TCP connection.

Adjuster component 1235 may adjust the time stamp value based at least in part on a radio impairment event, where the radio impairment event is scheduled or predicted to occur within a defined amount of time. In some cases, adjusting the time stamp value includes determining a clock granularity between a modem and at least one of a local operating system of the communication device or the remote host. In some cases, adjusting the time stamp value includes determining an amount of time to adjust the time stamp value based at least in part on the clock granularity, and translating the determined amount of time into a time unit of the local operating system of the communication device or the remote host.

Scheduler component 1240 may determine that a radio impairment event is scheduled or predicted to occur within a defined amount of time.

Delay determiner component 1245 may determine a duration of a delay based at least in part on a defined range of time of the radio impairment event, delay communicating a TCP acknowledgement packet over the TCP connection by at least the duration of the delay, and associate the current time with a particular one of a set of time regions with respect to the radio impairment event, where the duration of the delay is further based at least in part on the particular time region. In some cases, determining the duration of the delay further includes determining a current time relative to when the radio impairment event is scheduled or predicted to occur. In some cases, determining the duration of a delay includes determining a clock granularity between a modem and at least one of the local operating system of the communication device or the remote host. In some cases, delaying communicating the TCP acknowledgement includes delaying transmitting the TCP acknowledgement packet to a lower radio layer. In some cases, delaying communicating the TCP acknowledgement packet includes delaying reception of the TCP acknowledgement packet by an upper radio layer. In some cases, an error rate is detected and a radio impairment event is predicted to occur based at least part on the detected error rate. In some cases, a handover is detected to occur (e.g., a handover instruction is received) and a radio impairment event is predicted to occur based at least part on the detected handover.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1435 described with reference to FIG. 14. The transmitter 1220 may include a single antenna, or it may include a set of antennas.

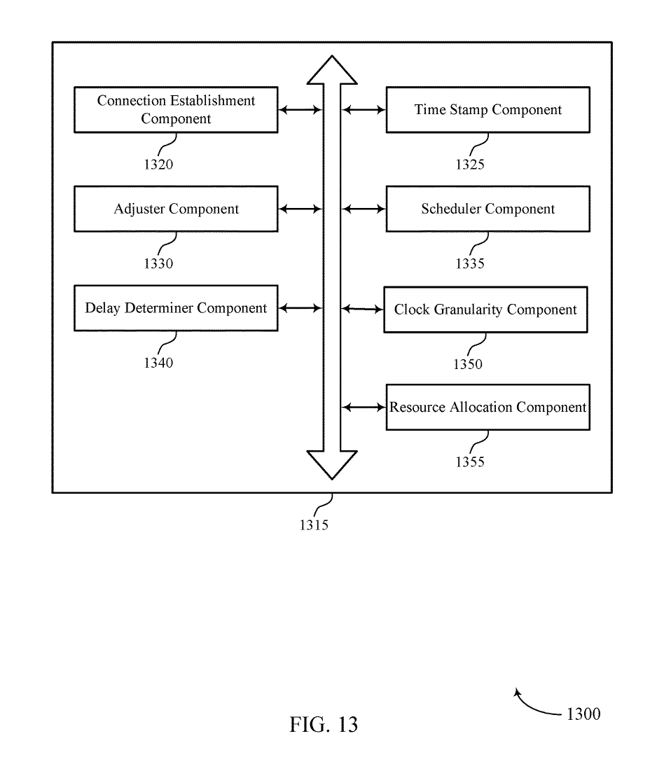

FIG. 13 shows a block diagram 1300 of a communications manager 1315 that supports mitigation of throughput degradation due to predictable radio impairment events in accordance with various aspects of the present disclosure. The communications manager 1315 may be an example of aspects of a communications manager 1115, a communications manager 1215, or a communications manager 1415 described with reference to FIGS. 11, 12, and 14. The communications manager 1315 may include connection establishment component 1320, time stamp component 1325, adjuster component 1330, scheduler component 1335, delay determiner component 1340, clock granularity component 1350, and resource allocation component 1355. Each of these modules may communicate, directly or indirectly, with one another (e.g., via one or more buses).

Connection establishment component 1320 may establish a transmission control protocol (TCP) connection with a remote host via a first RAT.

Time stamp component 1325 may determine a time stamp value associated with traffic of the TCP connection.

Adjuster component 1330 may adjust the time stamp value based at least in part on a radio impairment event, where the radio impairment event is scheduled or predicted to occur within a defined amount of time. In some cases, adjusting the time stamp value includes determining a clock granularity between a modem and at least one of the local operating system of a communication device or the remote host. In some cases, adjusting the time stamp value includes determining an amount of time to adjust the time stamp value based at least in part on the clock granularity, and translating the determined amount of time into a time unit of the local operating system at the communication device or the remote host.

Scheduler component 1335 may determine that a radio impairment event is scheduled or predicted to occur within a defined amount of time.

Delay determiner component 1340 may determine a duration of a delay based at least in part on a defined range of time of the radio impairment event, delay communicating a TCP acknowledgement packet over the TCP connection by at least the duration of the delay, and associate the current time with a particular one of a set of time regions with respect to the radio impairment event, where the duration of the delay is further based at least in part on the particular time region. In some cases, determining the duration of the delay further includes determining a current time relative to when the radio impairment event is scheduled or predicted to occur. In some cases, determining the duration of a delay includes determining a clock granularity between a modem and at least one of a local operating system of the communication device or the remote host. In some cases, delaying communicating the TCP acknowledgement includes delaying transmitting the TCP acknowledgement packet to a lower radio layer. In some cases, delaying communicating the TCP acknowledgement packet includes delaying reception of the TCP acknowledgement packet by an upper radio layer. In some cases, the particular time region includes a first time region, and where determining the duration of the delay includes calculating the duration of the delay as a function of the round trip time or a defined range of the duration of the radio impairment event, where the duration of the delay linearly increases across the first time region as the current time approaches a time of the radio impairment event. In some cases, the particular time region includes a second time region, and where determining the duration of the delay includes calculating a constant value for the duration of the delay as a function of the round trip time or a defined range of the duration of the radio impairment event. In some cases, an error rate is detected and a radio impairment event is predicted to occur based at least part on the detected error rate. In some cases, a handover is detected to occur (e.g., a handover instruction is received) and a radio impairment event is predicted to occur based at least part on the detected handover.

Clock granularity component 1350 may determine a clock granularity. In some cases, a first TCP packet is received at a first time and includes a first time stamp value, and a second TCP packet is received at a second time and includes second time stamp value, where the clock granularity is based at least in part on the first time, the first time stamp value, the second time, and the second time stamp value, determine a round trip time associated with the TCP connection based at least in part on the clock granularity, and determine that the radio impairment event is scheduled or predicted to occur within the defined amount of time is based at least in part on the round trip time. In some cases, the TCP connection is associated with a TCP clock. In some cases, an amount of adjustment to the time stamp value is further based at least in part on the clock granularity or a defined range of the duration of the radio impairment event. In some cases, the radio impairment event is a tuneaway event. In some cases, determining the duration of a delay includes determining an amount of time based at least in part on the clock granularity. In some cases, determining the clock granularity includes receiving, at a first time, a first TCP packet having a first time stamp value. In some cases, the clock granularity is based at least in part on the first time, the first time stamp value, the second time, and the second time stamp value. In some cases, the particular time region includes a third time region, and where determining the duration of the delay includes calculating the duration of the delay as a function of the round trip time or a defined range of the duration of the radio impairment event, where the duration of the delay linearly decreases across the third time region as the current time approaches a time of the radio impairment event.

Resource allocation component 1355 may allocate, for a time period associated with a duration of the radio impairment event, use of a subset of resources of the communication device to a second RAT and simultaneously preventing the first RAT from using the subset of resources during the time period, monitor, via the subset of resources, for a paging signal over the second RAT during the time period, transmit the TCP acknowledgement packet over the TCP connection prior to the radio impairment event,

FIG. 14 shows a diagram of a system 1400 including a device 1405 that supports mitigation of throughput degradation due to predictable radio impairment events in accordance with various aspects of the present disclosure. Device 1405 may be an example of or include the components of wireless device 1105, wireless device 1205, or a communication device 115 as described above, e.g., with reference to FIGS. 1, 11 and 12. Device 1405 may include components for bi-directional voice and data communications including components for transmitting and receiving communications, including communications manager 1415, processor 1420, memory 1425, software 1430, transceiver 1435, antenna 1440, and I/O controller 1445.

Processor 1420 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 1420 may be configured to operate a memory array using a memory controller. In other cases, a memory controller may be integrated into processor 1420. Processor 1420 may be configured to execute computer-readable instructions stored in a memory to perform various functions (e.g., functions or tasks supporting mitigation of throughput degradation due to predictable radio impairment events).

Memory 1425 may include random access memory (RAM) and read only memory (ROM). The memory 1425 may store computer-readable, computer-executable software 1430 including instructions that, when executed, cause the processor to perform various functions described herein. In some cases, the memory 1425 may contain, among other things, a Basic Input-Output system (BIOS) which may control basic hardware and/or software operation such as the interaction with peripheral components or devices.

Software 1430 may include code to implement aspects of the present disclosure, including code to support mitigation of throughput degradation due to predictable radio impairment events. Software 1430 may be stored in a non-transitory computer-readable medium such as system memory or other memory. In some cases, the software 1430 may not be directly executable by the processor but may cause a computer (e.g., when compiled and executed) to perform functions described herein.

Transceiver 1435 may communicate bi-directionally, via one or more antennas, wired, or wireless links as described above. For example, the transceiver 1435 may represent a wireless transceiver and may communicate bi-directionally with another wireless transceiver. The transceiver 1435 may also include a modem to modulate the packets and provide the modulated packets to the antennas for transmission, and to demodulate packets received from the antennas.

In some cases, the wireless device may include a single antenna 1440. However, in some cases the device may have more than one antenna 1440, which may be capable of concurrently transmitting or receiving multiple wireless transmissions.

I/O controller 1445 may manage input and output signals for device 1405. Input/output control component 1445 may also manage peripherals not integrated into device 1405. In some cases, input/output control component 1445 may represent a physical connection or port to an external peripheral. In some cases, I/O controller 1445 may utilize an operating system such as iOS®, ANDROID®, MS-DOS®, MS-WINDOWS®, OS/2®, UNIX®, LINUX®, or another known operating system.

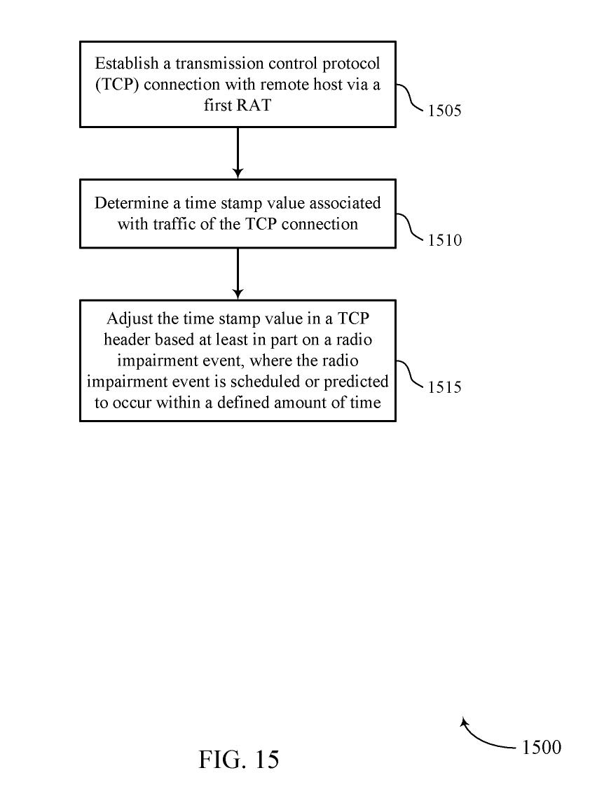

FIG. 15 shows a flowchart illustrating a method 1500 for mitigation of throughput degradation due to predictable radio impairment events in accordance with various aspects of the present disclosure. The operations of method 1500 may be implemented by a communication device 115 or its components as described herein. For example, the operations of method 1500 may be performed by a communications manager as described with reference to FIGS. 11 through 14. In some examples, a communication device 115 may execute a set of codes to control the functional elements of the device to perform the functions described below. Additionally or alternatively, the communication device 115 may perform aspects the functions described below using special-purpose hardware.

At block 1505 the communication device 115 may establish a transmission control protocol (TCP) connection with a remote host via a first RAT. The operations of block 1505 described with reference to FIGS. 1 through 10. In certain examples, aspects of the operations of block 1505 may be performed by a connection establishment component as described with reference to FIGS. 11 through 14.

At block 1510 the communication device 115 may determine a time stamp value associated with traffic of the TCP connection. The operations of block 1510 may be performed according to the methods described with reference to FIGS. 1 through 10. In certain examples, aspects of the operations of block 1510 may be performed by a time stamp component as described with reference to FIGS. 11 through 14.

At block 1515 the communication device 115 may adjust the time stamp value in a TCP header based at least in part on a radio impairment event, where the radio impairment event is scheduled or predicted to occur within a defined amount of time. The operations of block 1515 may be performed according to the methods described with reference to FIGS. 1 through 10. In certain examples, aspects of the operations of block 1515 may be performed by an adjuster component as described with reference to FIGS. 11 through 14.

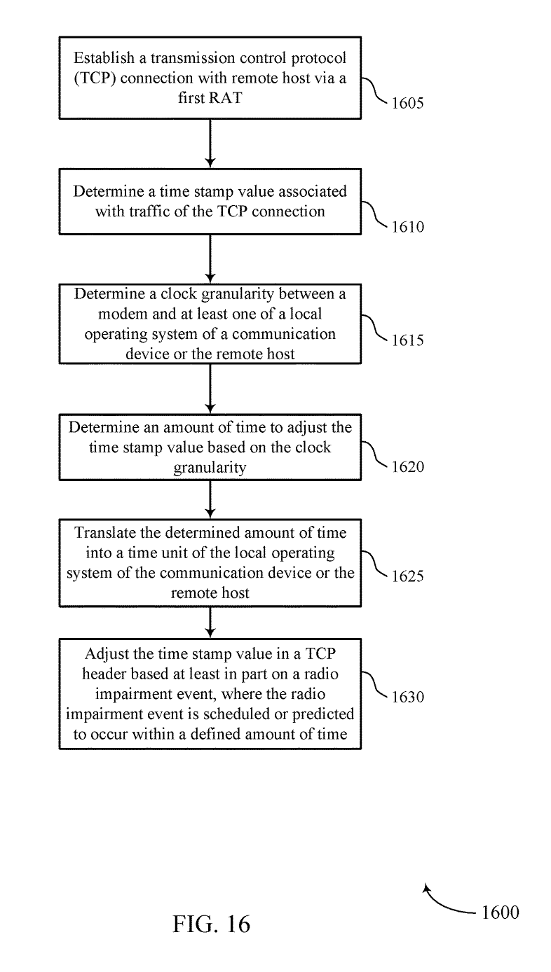

FIG. 16 shows a flowchart illustrating a method 1600 for mitigation of throughput degradation due to predictable radio impairment events in accordance with various aspects of the present disclosure. The operations of method 1600 may be implemented by a communication device 115 or its components as described herein. For example, the operations of method 1600 may be performed by a communications manager as described with reference to FIGS. 11 through 14. In some examples, a communication device 115 may execute a set of codes to control the functional elements of the device to perform the functions described below. Additionally or alternatively, the communication device 115 may perform aspects the functions described below using special-purpose hardware.

At block 1605 the communication device 115 may establish a transmission control protocol (TCP) connection with a remote host via a first RAT. The operations of block 1605 may be performed according to the methods described with reference to FIGS. 1 through 10. In certain examples, aspects of the operations of block 1605 may be performed by a connection establishment component as described with reference to FIGS. 11 through 14.

At block 1610 the communication device 115 may determine a time stamp value associated with traffic of the TCP connection. The operations of block 1610 may be performed according to the methods described with reference to FIGS. 1 through 10. In certain examples, aspects of the operations of block 1610 may be performed by a time stamp component as described with reference to FIGS. 11 through 14.

At block 1615 the communication device 115 may determine a clock granularity between a modem and at least one of a local operating system of the communication device or the remote host. The operations of block 1615 may be performed according to the methods described with reference to FIGS. 1 through 10. In certain examples, aspects of the operations of block 1615 may be performed by an adjuster component as described with reference to FIGS. 11 through 14.

At block 1620 the communication device 115 may determine an amount of time to adjust the time stamp value based at least in part on the clock granularity. The operations of block 1620 may be performed according to the methods described with reference to FIGS. 1 through 10. In certain examples, aspects of the operations of block 1620 may be performed by an adjuster component as described with reference to FIGS. 11 through 14.

At block 1625 the communication device 115 may translate the determined amount of time into a time unit of the local operating system of the communication device or the remote host. The operations of block 1625 may be performed according to the methods described with reference to FIGS. 1 through 10. In certain examples, aspects of the operations of block 1625 may be performed by an adjuster component as described with reference to FIGS. 11 through 14.

At block 1630 the communication device 115 may adjust the time stamp value in a TCP header based at least in part on a radio impairment event, where the radio impairment event is scheduled or predicted to occur within a defined amount of time. The operations of block 1630 may be performed according to the methods described with reference to FIGS. 1 through 10. In certain examples, aspects of the operations of block 1630 may be performed by an adjuster component as described with reference to FIGS. 11 through 14.

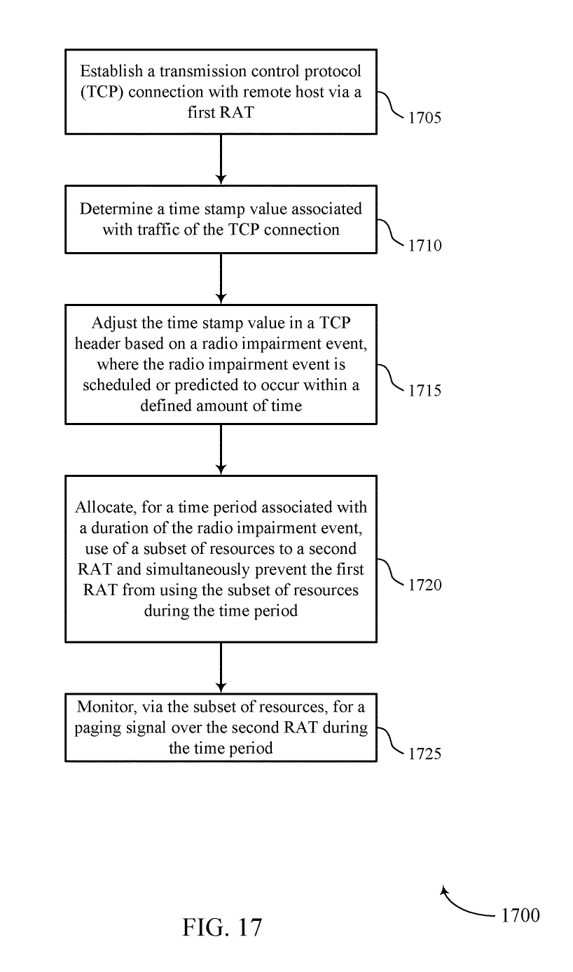

FIG. 17 shows a flowchart illustrating a method 1700 for mitigation of throughput degradation due to predictable radio impairment events in accordance with various aspects of the present disclosure. The operations of method 1700 may be implemented by a communication device 115 or its components as described herein. For example, the operations of method 1700 may be performed by a communications manager as described with reference to FIGS. 11 through 14. In some examples, a communication device 115 may execute a set of codes to control the functional elements of the device to perform the functions described below. Additionally or alternatively, the communication device 115 may perform aspects the functions described below using special-purpose hardware.

At block 1705 the communication device 115 may establish a transmission control protocol (TCP) connection with a remote host via a first RAT. The operations of block 1705 may be performed according to the methods described with reference to FIGS. 1 through 10. In certain examples, aspects of the operations of block 1705 may be performed by a connection establishment component as described with reference to FIGS. 11 through 14.

At block 1710 the communication device 115 may determine a time stamp value associated with traffic of the TCP connection. The operations of block 1710 may be performed according to the methods described with reference to FIGS. 1 through 10. In certain examples, aspects of the operations of block 1710 may be performed by a time stamp component as described with reference to FIGS. 11 through 14.

At block 1715 the communication device 115 may adjust the time stamp value in a TCP header based at least in part on a radio impairment event, where the radio impairment event is scheduled or predicted to occur within a defined amount of time. The operations of block 1715 may be performed according to the methods described with reference to FIGS. 1 through 10. In certain examples, aspects of the operations of block 1715 may be performed by an adjuster component as described with reference to FIGS. 11 through 14.

At block 1720 the communication device 115 may allocate, for a time period associated with a duration of the radio impairment event, use of a subset of resources of the communication device to a second RAT and simultaneously prevent the first RAT from using the subset of resources during the time period. The operations of block 1720 may be performed according to the methods described with reference to FIGS. 1 through 10. In certain examples, aspects of the operations of block 1720 may be performed by a resource allocation component as described with reference to FIGS. 11 through 14.

At block 1725 the communication device 115 may monitor, via the subset of resources, for a paging signal over the second RAT during the time period. The operations of block 1725 may be performed according to the methods described with reference to FIGS. 1 through 10. In certain examples, aspects of the operations of block 1725 may be performed by a resource allocation component as described with reference to FIGS. 11 through 14.

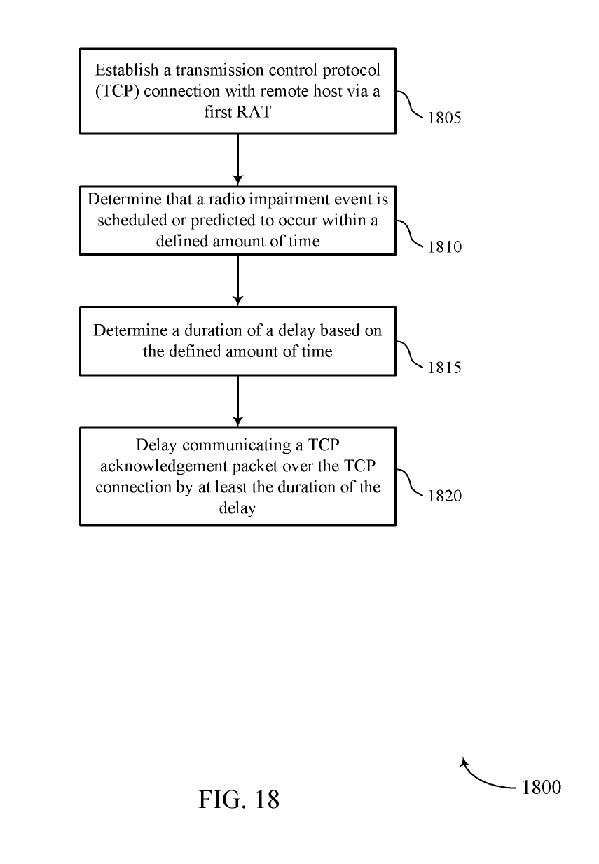

FIG. 18 shows a flowchart illustrating a method 1800 for mitigation of throughput degradation due to predictable radio impairment events in accordance with various aspects of the present disclosure. The operations of method 1800 may be implemented by a communication device 115 or its components as described herein. For example, the operations of method 1800 may be performed by a communications manager as described with reference to FIGS. 1 through 10. In some examples, a communication device 115 may execute a set of codes to control the functional elements of the device to perform the functions described below. Additionally or alternatively, the communication device 115 may perform aspects the functions described below using special-purpose hardware.

At block 1805 the communication device 115 may establish a transmission control protocol (TCP) connection with a remote host via a first RAT. The operations of block 1805 may be performed according to the methods described with reference to FIGS. 1 through 10. In certain examples, aspects of the operations of block 1805 may be performed by a connection establishment component as described with reference to FIGS. 11 through 14.

At block 1810 the communication device 115 may determine that a radio impairment event is scheduled or predicted to occur within a defined amount of time. The operations of block 1810 may be performed according to the methods described with reference to FIGS. 1 through 10. In certain examples, aspects of the operations of block 1810 may be performed by a scheduler component as described with reference to FIGS. 11 through 14.

At block 1815 the communication device 115 may determine a duration of a delay based at least in part on a defined range of time of the radio impairment event. The operations of block 1815 may be performed according to the methods described with reference to FIGS. 1 through 10. In certain examples, aspects of the operations of block 1815 may be performed by a delay determiner component as described with reference to FIGS. 11 through 14.

At block 1820 the communication device 115 may delay communicating a TCP acknowledgement packet over the TCP connection by at least the duration of the delay. The operations of block 1820 may be performed according to the methods described with reference to FIGS. 1 through 10. In certain examples, aspects of the operations of block 1820 may be performed by a delay determiner component as described with reference to FIGS. 11 through 14.

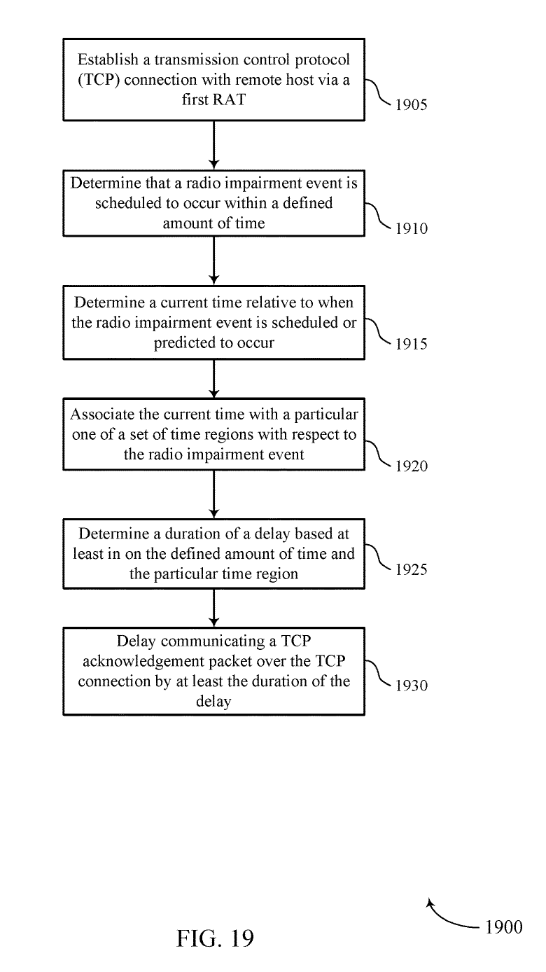

FIG. 19 shows a flowchart illustrating a method 1900 for mitigation of throughput degradation due to predictable radio impairment events in accordance with various aspects of the present disclosure. The operations of method 1900 may be implemented by a communication device 115 or its components as described herein. For example, the operations of method 1900 may be performed by a communications manager as described with reference to FIGS. 11 through 14. In some examples, a communication device 115 may execute a set of codes to control the functional elements of the device to perform the functions described below. Additionally or alternatively, the communication device 115 may perform aspects the functions described below using special-purpose hardware.

At block 1905 the communication device 115 may establish a transmission control protocol (TCP) connection with a remote host via a first RAT. The operations of block 1905 may be performed according to the methods described with reference to FIGS. 1 through 10. In certain examples, aspects of the operations of block 1905 may be performed by a connection establishment component as described with reference to FIGS. 11 through 14.

At block 1910 the communication device 115 may determine that a radio impairment event is scheduled or predicted to occur within a defined amount of time. The operations of block 1910 may be performed according to the methods described with reference to FIGS. 1 through 10. In certain examples, aspects of the operations of block 1910 may be performed by a scheduler component as described with reference to FIGS. 11 through 14.

At block 1915 the communication device 115 may determine a current time relative to when the radio impairment event is scheduled or predicted to occur. The operations of block 1915 may be performed according to the methods described with reference to FIGS. 1 through 10. In certain examples, aspects of the operations of block 1915 may be performed by a delay determiner component as described with reference to FIGS. 11 through 14.

At block 1920 the communication device 115 may associate the current time with a particular one of a set of time regions with respect to the radio impairment event. The operations of block 1920 may be performed according to the methods described with reference to FIGS. 1 through 10. In certain examples, aspects of the operations of block 1920 may be performed by a delay determiner component as described with reference to FIGS. 11 through 14.

At block 1925 the communication device 115 may determine a duration of a delay based at least in part on a defined range of time of the radio impairment event and the particular time region. The operations of block 1925 may be performed according to the methods described with reference to FIGS. 1 through 10. In certain examples, aspects of the operations of block 1925 may be performed by a delay determiner component as described with reference to FIGS. 11 through 14.

At block 1930 the communication device 115 may delay communicating a TCP acknowledgement packet over the TCP connection by at least the duration of the delay. The operations of block 1930 may be performed according to the methods described with reference to FIGS. 1 through 10. In certain examples, aspects of the operations of block 1930 may be performed by a delay determiner component as described with reference to FIGS. 11 through 14.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The communication devices described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by communication devices with service subscriptions with the network provider. A femto cell may also cover a small geographic area (e.g., a home) and may provide restricted access by communication devices having an association with the femto cell (e.g., communication devices in a closed subscriber group (CSG), communication devices for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A communication device may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
establishing a transmission control protocol (TCP) connection with a remote host via a first radio access technology (RAT);
determining a time stamp value associated with traffic of the TCP connection; and
adjusting the time stamp value in a TCP header based at least in part on a radio impairment event, wherein the radio impairment event is scheduled or predicted to occur within a defined amount of time.

2. The method of claim 1, further comprising:
transmitting a TCP packet comprising the adjusted time stamp value over the TCP connection prior to the radio impairment event.

3. The method of claim 1, wherein adjusting the time stamp value comprises:
determining a clock granularity between a modem and at least one of a local operating system of a communication device or the remote host.

4. The method of claim 3, wherein adjusting the time stamp value comprises:
determining an amount of time to adjust the time stamp value based at least in part on the clock granularity; and
translating the determined amount of time into a time unit of the local operating system of the communication device or the remote host.

5. The method of claim 3, further comprising:
determining a round trip time associated with the TCP connection based at least in part on the clock granularity, wherein the time stamp value is adjusted based at least in part on the round trip time or a defined range of a duration of the radio impairment event.

6. The method of claim 5, further comprising:
receiving, at a first time, a first TCP packet comprising a first time stamp value; and
receiving, at a second time, a second TCP packet comprising a second time stamp value, wherein the clock granularity is based at least in part on the first time, the first time stamp value, the second time, and the second time stamp value.

7. The method of claim 3, wherein an amount of adjustment to the time stamp value is further based at least in part on the clock granularity or a defined range of a duration of the radio impairment event.

8. The method of claim 1, further comprising:
allocating, for a time period associated with a defined range of a duration of the radio impairment event, use of a subset of resources of a communication device to a second RAT and simultaneously preventing the first RAT from using the subset of resources during the time period.

9. The method of claim 8, further comprising:
monitoring, via the subset of resources, for a paging signal over the second RAT during the time period.

10. The method of claim 1, wherein the radio impairment event is a tuneaway event.

11. The method of claim 1, wherein the TCP connection is associated with a TCP clock.

12. The method of claim 1, further comprising:
detecting an error rate; and
predicting occurrence of the radio impairment event based at least part on the detected error rate.

13. The method of claim 1, further comprising:
detecting that a handover is to occur; and
predicting occurrence of the radio impairment event based at least part on the detected handover.

14. A method for wireless communication, comprising:
establishing a transmission control protocol (TCP) connection with a remote host via a first radio access technology (RAT);
determining that a radio impairment event is scheduled or predicted to occur within a defined amount of time;
determining a duration of a delay based at least in part on a defined range of time of the radio impairment event; and
delaying communicating a TCP acknowledgement packet over the TCP connection by at least the duration of the delay.

15. The method of claim 14, further comprising:
transmitting the TCP acknowledgement packet over the TCP connection prior to the radio impairment event.

16. The method of claim 14, wherein determining the duration of the delay further comprises:
determining a current time relative to when the radio impairment event is scheduled or predicted to occur; and
associating the current time with a particular one of a plurality of time regions with respect to the radio impairment event,
wherein the duration of the delay is further based at least in part on the particular time region.

17. The method of claim 16, further comprising:
determining a round trip time associated with the TCP connection, wherein each of the plurality of time regions is associated with a different calculation for determining the duration of the delay as a function of the round trip time or a defined range of a duration of the radio impairment event.

18. The method of claim 17, wherein the particular time region comprises a first time region, and wherein determining the duration of the delay comprises:
calculating the duration of the delay as a function of the round trip time or the defined range of the duration of the radio impairment event,
wherein the duration of the delay linearly increases across the first time region as the current time approaches a time of the radio impairment event.

19. The method of claim 17, wherein the particular time region comprises a second time region, and wherein determining the duration of the delay comprises:
calculating a constant value for the duration of the delay as a function of the round trip time or the defined range of the duration of the radio impairment event.

20. The method of claim 17, wherein the particular time region comprises a third time region, and wherein determining the duration of the delay comprises:
calculating the duration of the delay as a function of the round trip time or the defined range of the duration of the radio impairment event,
wherein the duration of the delay linearly decreases across the third time region as the current time approaches a time of the radio impairment event.

21. The method of claim 20, further comprising:
generating a consolidated TCP acknowledgement packet based at least in part on the current time and the time of the radio impairment event,
wherein the consolidated TCP acknowledgement packet includes acknowledgement data for a plurality of TCP packets received over the TCP connection.

22. The method of claim 21, further comprising:
transmitting the consolidated TCP acknowledgement packet at a fixed amount of time prior to the radio impairment event.

23. The method of claim 14, wherein determining the duration of a delay comprises:
determining a clock granularity between a modem and at least one of a local operating system of a communication device or the remote host.

24. The method of claim 23, wherein determining the duration of a delay comprises:
determining an amount of time based at least in part on the clock granularity; and
translating the determined amount of time into a time unit of the local operating system of the communication device or the remote host.

25. The method of claim 23, wherein determining the clock granularity comprises:
receiving, at a first time, a first TCP packet having a first time stamp value; and
receiving, at a second time, a second TCP packet having a second time stamp value,
wherein the clock granularity is based at least in part on the first time, the first time stamp value, the second time, and the second time stamp value.

26. The method of claim 23, further comprising:
determining a round trip time associated with the TCP connection based at least in part on the clock granularity.

27. The method of claim 26, further comprising:
determining that the radio impairment event is scheduled or predicted to occur within the defined amount of time is based at least in part on the round trip time.

28. The method of claim 14, wherein the TCP connection is associated with a TCP clock.

29. The method of claim 14, wherein delaying communicating the TCP acknowledgement packet comprises:
delaying transmitting the TCP acknowledgement packet to a lower radio layer.

30. The method of claim 14, wherein delaying communicating the TCP acknowledgement packet comprises:
delaying reception of the TCP acknowledgement packet by an upper radio layer.

31. The method of claim 14, further comprising:
detecting an error rate; and
predicting occurrence of the radio impairment event based at least part on the detected error rate.

32. The method of claim 14, further comprising:
detecting that a handover is to occur; and
predicting occurrence of the radio impairment event based at least part on the detected handover.

33. An apparatus for wireless communication, comprising:
means for establishing a transmission control protocol (TCP) connection with a remote host via a first radio access technology (RAT);
means for determining a time stamp value associated with traffic of the TCP connection; and
means for adjusting the time stamp value in a TCP header based at least in part on a radio impairment event, wherein the radio impairment event is scheduled or predicted to occur within a defined amount of time.

34. The apparatus of claim 33, further comprising:
means for transmitting a TCP packet comprising the adjusted time stamp value over the TCP connection prior to the radio impairment event.

35. The apparatus of claim 33, wherein means for adjusting the time stamp value comprises:
means for determining a clock granularity between a modem and at least one of a local operating system or the remote host.

36. The apparatus of claim 35, wherein means for adjusting the time stamp value comprises:
means for determining an amount of time to adjust the time stamp value based at least in part on the clock granularity; and
means for translating the determined amount of time into a time unit of the local operating system or the remote host.

37. The apparatus of claim 35, further comprising:
means for determining a round trip time associated with the TCP connection based at least in part on the clock granularity, wherein the time stamp value is adjusted based at least in part on the round trip time or a defined range of a duration of the radio impairment event.

38. The apparatus of claim 37, further comprising:
means for receiving, at a first time, a first TCP packet comprising a first time stamp value; and
means for receiving, at a second time, a second TCP packet comprising a second time stamp value,
wherein the clock granularity is based at least in part on the first time, the first time stamp value, the second time, and the second time stamp value.

39. The apparatus of claim 35, wherein an amount of adjustment to the time stamp value is further based at least in part on the clock granularity or a defined range of a duration of the radio impairment event.

40. The apparatus of claim 33, further comprising:
means for allocating, for a time period associated with a defined range of a duration of the radio impairment event, use of a subset of resources to a second RAT and simultaneously preventing the first RAT from using the subset of resources during the time period.

41. The apparatus of claim 40, further comprising:
means for monitoring, via the subset of resources, for a paging signal over the second RAT during the time period.

42. The apparatus of claim 33, wherein the radio impairment event is a tuneaway event.

43. The apparatus of claim 33, wherein the TCP connection is associated with a TCP clock.

44. The apparatus of claim 33, further comprising:
means for detecting an error rate; and
means for predicting occurrence of the radio impairment event based at least part on the detected error rate.

45. The apparatus of claim 33, further comprising:
means for detecting that a handover is to occur; and
means for predicting occurrence of the radio impairment event based at least part on the detected handover.

46. An apparatus for wireless communication, comprising:
means for establishing a transmission control protocol (TCP) connection with a remote host via a first radio access technology (RAT);
means for determining that a radio impairment event is scheduled or predicted to occur within a defined amount of time;
means for determining a duration of a delay based at least in part on a defined range of time of the radio impairment event; and
means for delaying communicating a TCP acknowledgement packet over the TCP connection by at least the duration of the delay.

47. The apparatus of claim 46, further comprising:
means for transmitting the TCP acknowledgement packet over the TCP connection prior to the radio impairment event.

48. The apparatus of claim 46, wherein means for determining the duration of the delay further comprises:
means for determining a current time relative to when the radio impairment event is scheduled or predicted to occur; and
means for associating the current time with a particular one of a plurality of time regions with respect to the radio impairment event,
wherein the duration of the delay is further based at least in part on the particular time region.

49. The apparatus of claim 48, further comprising:
means for determining a round trip time associated with the TCP connection,
wherein each of the plurality of time regions is associated with a different calculation for determining the duration of the delay as a function of the round trip time or a defined range of a duration of the radio impairment event.

50. The apparatus of claim 49, wherein the particular time region comprises a first time region, and wherein means for determining the duration of the delay comprises:
means for calculating the duration of the delay as a function of the round trip time or the defined range of the duration of the radio impairment event,
wherein the duration of the delay linearly increases across the first time region as the current time approaches a time of the radio impairment event.

51. The apparatus of claim 49, wherein the particular time region comprises a second time region, and wherein means for determining the duration of the delay comprises:
means for calculating a constant value for the duration of the delay as a function of the round trip time or the defined range of the duration of the radio impairment event.

52. The apparatus of claim 49, wherein the particular time region comprises a third time region, and wherein means for determining the duration of the delay comprises:
means for calculating the duration of the delay as a function of the round trip time or the defined range of the duration of the radio impairment event, wherein the duration of the delay linearly decreases across the third time region as the current time approaches a time of the radio impairment event.

53. The apparatus of claim 52, further comprising:
means for generating a consolidated TCP acknowledgement packet based at least in part on the current time and the time of the radio impairment event,
wherein the consolidated TCP acknowledgement packet includes acknowledgement data for a plurality of TCP packets received over the TCP connection.

54. The apparatus of claim 53, further comprising:
means for transmitting the consolidated TCP acknowledgement packet at a fixed amount of time prior to the radio impairment event.

55. The apparatus of claim 46, wherein means for determining the duration of a delay comprises:
means for determining a clock granularity between a modem and at least one of a local operating system or the remote host.

56. The apparatus of claim 55, wherein means for determining the duration of a delay comprises:
means for determining an amount of time based at least in part on the clock granularity; and
means for translating the determined amount of time into a time unit of the local operating system or the remote host.

57. The apparatus of claim 55, wherein means for determining the clock granularity comprises:
means for receiving, at a first time, a first TCP packet having a first time stamp value;
means for receiving, at a second time, a second TCP packet having a second time stamp value, and
wherein the clock granularity is based at least in part on the first time, the first time stamp value, the second time, and the second time stamp value.

58. The apparatus of claim 55, further comprising:
means for determining a round trip time associated with the TCP connection based at least in part on the clock granularity.

59. The apparatus of claim 58, further comprising:
means for determining that the radio impairment event is scheduled or predicted to occur within the defined amount of time is based at least in part on the round trip time.

60. The apparatus of claim 46, wherein the TCP connection is associated with a TCP clock.

61. The apparatus of claim 46, wherein means for delaying communicating the TCP acknowledgement packet comprises:
means for delaying transmitting the TCP acknowledgement packet to a lower radio layer.

62. The apparatus of claim 46, wherein means for delaying communicating the TCP acknowledgement packet comprises:
means for delaying reception of the TCP acknowledgement packet by an upper radio layer.

63. The apparatus of claim 46, further comprising:
means for detecting an error rate; and
means for predicting occurrence of the radio impairment event based at least part on the detected error rate.

64. The apparatus of claim 46, further comprising:
means for detecting that a handover is to occur; and
means for predicting occurrence of the radio impairment event based at least part on the detected handover.

65. An apparatus for wireless communication, in a system comprising:
a processor;
memory in electronic communication with the processor; and
instructions stored in the memory and operable, when executed by the processor, to cause the apparatus to:
establish a transmission control protocol (TCP) connection with a remote host via a first radio access technology (RAT);
determine a time stamp value associated with traffic of the TCP connection; and
adjust the time stamp value in a TCP header based at least in part on a radio impairment event, wherein the radio impairment event is scheduled or predicted to occur within a defined amount of time.

66. The apparatus of claim 65, wherein the instructions are further executable by the processor to:
transmit a TCP packet comprising the adjusted time stamp value over the TCP connection prior to the radio impairment event.

67. The apparatus of claim 65, wherein
adjusting the time stamp value comprises: determining a clock granularity between a modem and at least one of a local operating system or the remote host.

68. The apparatus of claim 67, wherein adjusting the time stamp value comprises:
determining an amount of time to adjust the time stamp value based at least in part on the clock granularity; and
translating the determined amount of time into a time unit of the local operating system or the remote host.

69. The apparatus of claim 67, wherein the instructions are further executable by the processor to:
determine a round trip time associated with the TCP connection based at least in part on the clock granularity,
wherein the time stamp value is adjusted based at least in part on the round trip time or a defined range of a duration of the radio impairment event.

70. The apparatus of claim 69, wherein the instructions are further executable by the processor to:
receive, at a first time, a first TCP packet comprising a first time stamp value; and
receive, at a second time, a second TCP packet comprising a second time stamp value,
wherein the clock granularity is based at least in part on the first time, the first time stamp value, the second time, and the second time stamp value.

71. The apparatus of claim 67, wherein an amount of adjustment to the time stamp value is further based at least in part on the clock granularity or a defined range of a duration of the radio impairment event.

72. The apparatus of claim 65, wherein the instructions are further executable by the processor to:
allocate, for a time period associated with a defined range of a duration of the radio impairment event, use of a subset of resources to a second RAT and simultaneously prevent the first RAT from using the subset of resources during the time period.

73. The apparatus of claim 72, wherein the instructions are further executable by the processor to:
monitor, via the subset of resources, for a paging signal over the second RAT during the time period.

74. The apparatus of claim 65, wherein the radio impairment event is a tuneaway event.

75. The apparatus of claim 65, wherein the TCP connection is associated with a TCP clock.

76. The apparatus of claim 65, wherein the instructions are further executable by the processor to:
detect an error rate; and
predict occurrence of the radio impairment event based at least part on the detected error rate.

77. The apparatus of claim 65, wherein the instructions are further executable by the processor to:
detect that a handover is to occur; and
predict occurrence of the radio impairment event based at least part on the detected handover.

78. An apparatus for wireless communication, in a system comprising:
a processor;
memory in electronic communication with the processor; and
instructions stored in the memory and operable, when executed by the processor, to cause the apparatus to:
establish a transmission control protocol (TCP) connection with a remote host via a first radio access technology (RAT);
determine that a radio impairment event is scheduled or predicted to occur within a defined amount of time;
determine a duration of a delay based at least in part on a defined range of time of the radio impairment event; and
delay communicating a TCP acknowledgement packet over the TCP connection by at least the duration of the delay.

79. The apparatus of claim 78, wherein the instructions are further executable by the processor to:
transmit the TCP acknowledgement packet over the TCP connection prior to the radio impairment event.

80. The apparatus of claim 78, wherein determining the duration of the delay further comprises:
determining a current time relative to when the radio impairment event is scheduled or predicted to occur; and
associating the current time with a particular one of a plurality of time regions with respect to the radio impairment event, wherein the duration of the delay is further based at least in part on the particular time region.

81. The apparatus of claim 80, wherein the instructions are further executable by the processor to:
determine a round trip time associated with the TCP connection,
wherein each of the plurality of time regions is associated with a different calculation for determining the duration of the delay as a function of the round trip time or a defined range of a duration of the radio impairment event.

82. The apparatus of claim 81, wherein the particular time region comprises a first time region, and wherein determining the duration of the delay comprises:
calculating the duration of the delay as a function of the round trip time or the defined range of the duration of the radio impairment event,
wherein the duration of the delay linearly increases across the first time region as the current time approaches a time of the radio impairment event.

83. The apparatus of claim 81, wherein the particular time region comprises a second time region, and wherein determining the duration of the delay comprises:
calculating a constant value for the duration of the delay as a function of the round trip time or the defined range of the duration of the radio impairment event.

84. The apparatus of claim 81, wherein the particular time region comprises a third time region, and wherein determining the duration of the delay comprises:
calculating the duration of the delay as a function of the round trip time or the defined range of the duration of the radio impairment event,
wherein the duration of the delay linearly decreases across the third time region as the current time approaches a time of the radio impairment event.

85. The apparatus of claim 84, wherein the instructions are further executable by the processor to:
generate a consolidated TCP acknowledgement packet based at least in part on the current time and the time of the radio impairment event,
wherein the consolidated TCP acknowledgement packet includes acknowledgement data for a plurality of TCP packets received over the TCP connection.

86. The apparatus of claim 85, wherein the instructions are further executable by the processor to:
transmit the consolidated TCP acknowledgement packet at a fixed amount of time prior to the radio impairment event.

87. The apparatus of claim 78, wherein determining the duration of a delay comprises:
determining a clock granularity between a modem and at least one of a local operating system or the remote host.

88. The apparatus of claim 87, wherein determining the duration of a delay comprises:
determining an amount of time based at least in part on the clock granularity; and
translating the determined amount of time into a time unit of the local operating system or the remote host.

89. The apparatus of claim 87, wherein determining the clock granularity comprises:
receiving, at a first time, a first TCP packet having a first time stamp value;
receiving, at a second time, a second TCP packet having a second time stamp value, and
wherein the clock granularity is based at least in part on the first time, the first time stamp value, the second time, and the second time stamp value.

90. The apparatus of claim 87, wherein the instructions are further executable by the processor to:
determine a round trip time associated with the TCP connection based at least in part on the clock granularity.

91. The apparatus of claim 90, wherein the instructions are further executable by the processor to:
determine that the radio impairment event is scheduled or predicted to occur within the defined amount of time is based at least in part on the round trip time.

92. The apparatus of claim 78, wherein the TCP connection is associated with a TCP clock.

93. The apparatus of claim 78, wherein delaying communicating the TCP acknowledgement packet comprises:
delaying transmitting the TCP acknowledgement packet to a lower radio layer.

94. The apparatus of claim 78, wherein delaying communicating the TCP acknowledgement packet comprises:
delaying reception of the TCP acknowledgement packet by an upper radio layer.

95. The apparatus of claim 78, wherein the instructions are further executable by the processor to:
detect an error rate; and
predict occurrence of the radio impairment event based at least part on the detected error rate.

96. The apparatus of claim 78, wherein the instructions are further executable by the processor to:
detect that a handover is to occur; and
predict occurrence of the radio impairment event based at least part on the detected handover.

97. A non-transitory computer-readable medium storing code for wireless communication, the code comprising instructions executable by a processor to:
establish a transmission control protocol (TCP) connection with a remote host via a first radio access technology (RAT);
determine a time stamp value associated with traffic of the TCP connection; and
adjust the time stamp value in a TCP header based at least in part on a radio impairment event, wherein the radio impairment event is scheduled or predicted to occur within a defined amount of time.

98. The non-transitory computer-readable medium of claim 97, wherein the instructions are further executable by the processor to:
transmit a TCP packet comprising the adjusted time stamp value over the TCP connection prior to the radio impairment event.

99. The non-transitory computer-readable medium of claim 97, wherein adjusting the time stamp value comprises:
determining a clock granularity between a modem and at least one of a local operating system of a communication device or the remote host.

100. The non-transitory computer-readable medium of claim 99, wherein adjusting the time stamp value comprises:
determining an amount of time to adjust the time stamp value based at least in part on the clock granularity; and
translating the determined amount of time into a time unit of the local operating system of the communication device or the remote host.

101. The non-transitory computer-readable medium of claim 99, wherein the instructions are further executable by the processor to:
determine a round trip time associated with the TCP connection based at least in part on the clock granularity,
wherein the time stamp value is adjusted based at least in part on the round trip time or a defined range of a duration of the radio impairment event.

102. The non-transitory computer-readable medium of claim 101, wherein the instructions are further executable by the processor to:
receive, at a first time, a first TCP packet comprising a first time stamp value; and
receive, at a second time, a second TCP packet comprising a second time stamp value,
wherein the clock granularity is based at least in part on the first time, the first time stamp value, the second time, and the second time stamp value.

103. The non-transitory computer-readable medium of claim 99, wherein an amount of adjustment to the time stamp value is further based at least in part on the clock granularity or a defined range of a duration of the radio impairment event.

104. The non-transitory computer-readable medium of claim 97, wherein the instructions are further executable by the processor to:
allocate, for a time period associated with a defined range of a duration of the radio impairment event, use of a subset of resources of a communication device to a second RAT and simultaneously prevent the first RAT from using the subset of resources during the time period.

105. The non-transitory computer-readable medium of claim 104, wherein the instructions are further executable by the processor to:
monitor, via the subset of resources, for a paging signal over the second RAT during the time period.

106. The non-transitory computer-readable medium of claim 97, wherein the radio impairment event is a tuneaway event.

107. The non-transitory computer-readable medium of claim 97, wherein the TCP connection is associated with a TCP clock.

108. The non-transitory computer-readable medium of claim 97, wherein the instructions are further executable by the processor to:
detect an error rate; and
predict occurrence of the radio impairment event based at least part on the detected error rate.

109. The non-transitory computer-readable medium of claim 97, wherein the instructions are further executable by the processor to:
detect that a handover is to occur; and
predict occurrence of the radio impairment event based at least part on the detected handover.

110. A non-transitory computer-readable medium storing code for wireless communication, the code comprising instructions executable by a processor to:
establish a transmission control protocol (TCP) connection with a remote host via a first radio access technology (RAT);
determine that a radio impairment event is scheduled or predicted to occur within a defined amount of time;
determine a duration of a delay based at least in part on a defined range of time of the radio impairment event; and
delay communicating a TCP acknowledgement packet over the TCP connection by at least the duration of the delay.

111. The non-transitory computer-readable medium of claim 110, wherein the instructions are further executable by the processor to:
transmit the TCP acknowledgement packet over the TCP connection prior to the radio impairment event.

112. The non-transitory computer-readable medium of claim 110, wherein determining the duration of the delay further comprises:
determining a current time relative to when the radio impairment event is scheduled or predicted to occur; and
associate the current time with a particular one of a plurality of time regions with respect to the radio impairment event,
wherein the duration of the delay is further based at least in part on the particular time region.

113. The non-transitory computer-readable medium of claim 112, wherein the instructions are further executable by the processor to:
determine a round trip time associated with the TCP connection,
wherein each of the plurality of time regions is associated with a different calculation for determining the duration of the delay as a function of the round trip time or a defined range of a duration of the radio impairment event.

114. The non-transitory computer-readable medium of claim 113, wherein the particular time region comprises a first time region, and wherein determining the duration of the delay comprises:
calculating the duration of the delay as a function of the round trip time or the defined range of the duration of the radio impairment event,
wherein the duration of the delay linearly increases across the first time region as the current time approaches a time of the radio impairment event.

115. The non-transitory computer-readable medium of claim 113, wherein the particular time region comprises a second time region, and wherein determining the duration of the delay comprises:
calculating a constant value for the duration of the delay as a function of the round trip time or the defined range of the duration of the radio impairment event.

116. The non-transitory computer-readable medium of claim 113, wherein the particular time region comprises a third time region, and wherein determining the duration of the delay comprises:
calculating the duration of the delay as a function of the round trip time or the defined range of the duration of the radio impairment event,
wherein the duration of the delay linearly decreases across the third time region as the current time approaches a time of the radio impairment event.

117. The non-transitory computer-readable medium of claim 116, wherein the instructions are further executable by the processor to:
generate a consolidated TCP acknowledgement packet based at least in part on the current time and the time of the radio impairment event,
wherein the consolidated TCP acknowledgement packet includes acknowledgement data for a plurality of TCP packets received over the TCP connection.

118. The non-transitory computer-readable medium of claim 117, wherein the instructions are further executable by the processor to:
transmit the consolidated TCP acknowledgement packet at a fixed amount of time prior to the radio impairment event.

119. The non-transitory computer-readable medium of claim 110, wherein determining the duration of a delay comprises:
determining a clock granularity between a modem and at least one of a local operating system of a communication device or the remote host.

120. The non-transitory computer-readable medium of claim 119, wherein determining the duration of a delay comprises:
determining an amount of time based at least in part on the clock granularity; and
translating the determined amount of time into a time unit of the local operating system of the communication device or the remote host.

121. The non-transitory computer-readable medium of claim 119, wherein determining the clock granularity comprises:
receiving, at a first time, a first TCP packet having a first time stamp value;
receiving, at a second time, a second TCP packet having a second time stamp value,
wherein the clock granularity is based at least in part on the first time, the first time stamp value, the second time, and the second time stamp value.

122. The non-transitory computer-readable medium of claim 119, wherein the instructions are further executable by the processor to:
determine a round trip time associated with the TCP connection based at least in part on the clock granularity.

123. The non-transitory computer-readable medium of claim 122, wherein the instructions are further executable by the processor to:
determine that the radio impairment event is scheduled or predicted to occur within the defined amount of time is based at least in part on the round trip time.

124. The non-transitory computer-readable medium of claim 110, wherein the TCP connection is associated with a TCP clock.

125. The non-transitory computer-readable medium of claim 110, wherein delaying communicating the TCP acknowledgement packet comprises:
delaying transmitting the TCP acknowledgement packet to a lower radio layer.

126. The non-transitory computer-readable medium of claim 110, wherein delaying communicating the TCP acknowledgement packet comprises:
delaying reception of the TCP acknowledgement packet by an upper radio layer.

127. The non-transitory computer-readable medium of claim 110, wherein the instructions are further executable by the processor to:
detect an error rate; and
predict occurrence of the radio impairment event based at least part on the detected error rate.

128. The non-transitory computer-readable medium of claim 110, wherein the instructions are further executable by the processor to:
detect that a handover is to occur; and
predict occurrence of the radio impairment event based at least part on the detected handover.
